(19) United States
(12) Patent Application Publication
(10) Pub. No.: US 2023/0309181 A1
(43) Pub. Date: Sep. 28, 2023

(54) MODE SWITCHING METHOD AND RELATED APPARATUS

(71) Applicant: HUAWEI TECHNOLOGIES CO., LTD., Shenzhen (CN)

(72) Inventors: Ting WANG, Shanghai (CN); Yongxia LYU, Shenzhen (CN); Jun WANG, Shanghai (CN); Jianglei MA, Ottawa (CA)

(21) Appl. No.: 18/308,007

(22) Filed: Apr. 27, 2023

Related U.S. Application Data
(63) Continuation of application No. PCT/CN2021/127237, filed on Oct. 29, 2021.

(30) Foreign Application Priority Data
Oct. 31, 2020 (CN) 202011199025.0

(51) Int. Cl. H04W 76/27

(52) U.S. Cl. CPC H04W 76/27

(57) ABSTRACT

Embodiments of this application disclose mode switching methods and apparatuses. In an example method, a first communication apparatus sends a first signal to a second communication apparatus, where the first signal indicates that the first communication apparatus requests to switch a mode of the first communication apparatus, the mode includes a first mode and a second mode, and there is a correspondence between the mode and a service type of the first communication apparatus.

### CROSS-REFERENCE TO RELATED APPLICATIONS

This application is a continuation of International Application No. PCT/CN2021/127237, filed on Oct. 29, 2021, which claims priority to Chinese Patent Application No. 202011199025.0, filed on Oct. 31, 2020. The disclosures of the aforementioned applications are hereby incorporated by reference in their entireties.

### TECHNICAL FIELD

Embodiments of this application relate to the communication field, and in particular, to a mode switching method and a related apparatus.

### BACKGROUND

A new radio (NR) system is a proposed 5th generation (5G) cellular mobile communication system. Compared with a long term evolution (LTE) system, the NR system can implement a larger transmission bandwidth, more transceiver antenna arrays, a higher transmission rate, and a more flexible scheduling mechanism with a smaller granularity.

Three states are defined in NR: idle state, inactive state, and connected state. A terminal device may be in only one state at a moment. When the terminal device is in the idle state, the terminal device may maintain only a basic link to an access network device. No radio resource control (RRC) link is established between the terminal device and the access network device, and therefore data transmission cannot be performed. When the terminal device is in the inactive state, the terminal device may maintain only the basic link to the access network device, and the terminal device may perform small-packet data transmission with the access network device. When the terminal device is in the connected state, the terminal device may perform data transmission with the access network device.

If the terminal device is currently in the idle state, when the terminal device needs to transmit data, the terminal device needs to switch from the idle state to the inactive state or the connected state. When the terminal device performs state transition, the terminal device needs to communicate with the access network device through a plurality of pieces of RRC signaling. Consequently, signaling overheads are high, and a signaling transmission delay is long.

### SUMMARY

According to a first aspect, an embodiment of this application provides a mode switching method, including:

A first communication apparatus sends a first signal to a second communication apparatus, where the first signal indicates that the first communication apparatus requests to perform mode switching, a mode includes a first mode and a second mode, and there is a correspondence between the mode and a service type of the first communication apparatus; and the first communication apparatus switches a mode.

When the first communication apparatus is in a service type, the first communication apparatus communicates with the second communication apparatus, and the first communication apparatus may communicate different content in different modes. In this way, energy saving of the communication apparatus is implemented and communication efficiency is improved. In addition, in different service types, standards for determining whether the first communication apparatus is in the first mode or the second mode may be different. When the first communication device switches a service type, the first communication apparatus may send a mode switching request signal to the second communication apparatus, so that mode switching can be implemented, and communication performance in the different service types can be met.

When the first communication apparatus performs mode switching (state transition), the first communication apparatus sends the first signal to the second communication apparatus to notify the second communication apparatus that the mode of the first communication apparatus changes. The mode of the first communication apparatus includes two modes: the first mode and the second mode, and the mode corresponds to the service type of the first communication apparatus. Modes can be user-defined, different communication requirements corresponding to various service types are met, energy consumption is reduced, signaling overheads and a delay of mode switching performed by the first communication apparatus are reduced, and communication efficiency is improved.

In a possible implementation, the first signal may belong to a physical layer signal.

In this embodiment of this application, when the first communication apparatus requests to perform mode switching, the physical layer signal is used, so that higher layer signaling interaction between the first communication apparatus and the second communication apparatus is reduced, a delay is reduced, and communication efficiency is improved.

In a possible implementation, there is a correspondence between the service type of the first communication apparatus and the foregoing mode. The following describes several first communication apparatuses with different service types. When the service type of the first communication apparatus is an enhanced mobile broadband (eMBB) type, the first mode includes an idle state and/or an inactive state and the first communication apparatus may have one or more of idle-state functions and/or inactive-state functions in an NR system, and the second mode includes a connected state and the first communication apparatus may have one or more of connected-state functions in the NR system. When the service type of the first communication apparatus is an internet of things (IoT) type, the first mode includes an idle state and the first communication apparatus may have one or more of idle-state functions in the NR system, and the second mode includes an inactive state and/or a connected state and the first communication apparatus may have one or more of inactive-state functions and/or connected-state functions in the existing NR system. Alternatively, when the service type of the first communication apparatus is an ultra-reliable low-latency communication (URLLC) type, the first mode includes an idle state and/or an inactive state and the first communication apparatus may have one or more of idle-state functions and/or inactive-state functions in the existing NR system, and the second mode includes a connected state and the first communication apparatus may have one or more of connected-state functions in the existing NR system. When the service type of the first communication apparatus is a CPE type, the first mode includes a first connected state and the first communication apparatus may have one or more of connected-state functions in the NR system, and the second mode includes a second connected state and the first communication apparatus may have one or more of the connected-state functions in the NR system.

In this embodiment of this application, a specific correspondence between the mode and the service type is proposed for several common service types. According to the foregoing design, two different modes or two states may be defined for different terminal types. Compared with that in the three states in the NR system, signaling overheads for mode switching can be reduced, a function of a mode or a state can be user-defined, and energy saving of the communication apparatus can be performed as required.

In a possible implementation, the first signal may be a sounding reference signal (SRS), a scheduling request (SR), or a preamble sequence.

In this embodiment of this application, a plurality of possible implementations are proposed for the first signal, to improve implementability of the solution. In addition, different implementations are applicable to different scenarios, to meet communication requirements in different scenarios.

In a possible implementation, the first signal includes identifier information of the first communication apparatus, so that the second communication apparatus can determine, based on the identifier information, the communication apparatus that sends the first signal.

In a possible implementation, the first signal is a dedicated mode switching request signal.

In this embodiment of this application, the first signal may be a dedicated mode switching request signal, and has features such as strong pertinence and flexible configuration. Therefore, resource overheads are reduced while a switching request is met.

In a possible implementation, there is a correspondence between a frame structure of the first signal and the service type of the first communication apparatus.

In this embodiment of this application, the frame structure is designed based on the service type of the first communication device, to implement frame structure customization, so that transmission requirements of first communication devices of different service types can be better met, and communication efficiency can be improved.

In a possible implementation, before switching the mode, the first communication apparatus may receive first response information from the second communication apparatus, and switch the mode based on the first response information.

In this embodiment of this application, the first communication apparatus may receive the first response information from the second communication apparatus, and perform mode switching based on the first response information. This enhances reliability of mode switching of the first communication apparatus. The first communication apparatus and the second communication apparatus have consistent understanding of the mode or the state.

In a possible implementation, the first response information includes downlink control information (DCI), an acknowledgment character (ACK), a negative acknowledgment character (NACK), or higher layer signaling.

In this embodiment of this application, a plurality of possible implementations are proposed for the first response information, to improve implementability of the solution. In addition, different implementations are applicable to different scenarios, to meet communication requirements in different scenarios.

In a possible implementation, the first signal may be used to request a group of communication apparatuses to perform mode switching, and the first communication apparatus is an apparatus in the foregoing group of communication apparatuses.

In this embodiment of this application, in the group of communication apparatuses, only the first communication apparatus sends a request. Compared with a case in which each communication apparatus sends a request signal, signal overheads can be reduced, energy saving of the communication apparatus can be implemented, and communication efficiency can be improved.

In a possible implementation, the first communication apparatus may receive second response information sent by the second communication apparatus.

In this embodiment of this application, the second communication apparatus may send the second response information to the first communication apparatus, to enhance mode switching reliability. The second communication apparatus and the first communication apparatus have a consistent understanding of the mode or the state.

In a possible implementation, after the first communication apparatus receives the second response information from the second communication apparatus, the first communication apparatus sends a mode switching indication to a third communication apparatus, where the third communication apparatus is an apparatus in the foregoing group of communication apparatuses. In this embodiment of this application, the first communication apparatus may indicate the third communication apparatus in the communication apparatus group in which the first communication apparatus is located to perform mode switching. The third communication apparatus may perform mode switching after receiving the mode switching indication of the first communication apparatus. To be specific, modes in the communication apparatus group may be consistent, so as to cooperatively complete data communication, thereby improving group communication efficiency.

In a possible implementation, the second response information may be DCI, an ACK, a NACK, or higher layer signaling.

In this embodiment of this application, the first response information and the second response information may be the same or may be different.

In this embodiment of this application, a plurality of possible implementations are proposed for the second response information, to improve implementability of the solution. In addition, different implementations are applicable to different scenarios, to meet communication requirements in different scenarios.

In a possible implementation, when the mode of the first communication apparatus is the second mode, the first communication apparatus switches from the second mode to the first mode based on a timing device such as a timer.

In this embodiment of this application, when the first communication apparatus does not receive a signal from the access network device within preset duration, the first communication apparatus switches from the second mode to the first mode. The first communication apparatus can implement quick switching, for example, switching from the second mode to the first mode. Therefore, signaling overheads are reduced, a switching delay is reduced, energy for the terminal device is saved, and communication efficiency is improved.

According to a second aspect, an embodiment of this application provides a mode switching method, including:

A second communication apparatus receives a first signal sent by a first communication apparatus, where the first signal is used by the first communication apparatus to request to perform mode switching, a mode includes a first mode and a second mode, and there is a correspondence between the mode and a service type of the first communication apparatus; and the second communication apparatus determines a mode of the first communication apparatus.

When the first communication apparatus is in a service type, the first communication apparatus communicates with the second communication apparatus, and the first communication apparatus may communicate different content in different modes. In this way, energy saving of the communication apparatus is implemented and communication efficiency is improved. In addition, in different service types, standards for determining whether the first communication apparatus is in the first mode or the second mode may be different. When the first communication device switches the service type, the second communication apparatus receives the first signal sent by the first communication apparatus, so that mode switching can be implemented, communication performance in different service types is met, and communication efficiency is improved.

When the first communication apparatus performs mode switching (state transition), the second communication apparatus learns, by receiving the first signal sent by the first communication device, that the mode of the first communication apparatus changes. The mode of the first communication apparatus includes two modes: the first mode and the second mode, and the mode corresponds to the service type of the first communication apparatus. Modes can be user-defined, different communication requirements corresponding to various service types are met, energy consumption is reduced, signaling overheads and a delay of mode switching performed by the first communication apparatus are reduced, and communication efficiency is improved.

In a possible implementation, the first signal may belong to a physical layer signal.

In this embodiment of this application, when the first communication apparatus requests to perform mode switching, the physical layer signal is used, so that higher layer signaling interaction between the first communication apparatus and the second communication apparatus is reduced, a delay is reduced, and communication efficiency is improved.

In a possible implementation, when there is a correspondence between the service type of the first communication apparatus and the foregoing mode, the following describes several first communication apparatuses with different service types. When the service type of the first communication apparatus is an eMBB type, the first mode includes an idle state and/or an inactive state and the first communication apparatus may have one or more of idle-state functions and/or inactive-state functions in an NR system, and the second mode includes a connected state and the first communication apparatus may have one or more of connected-state functions in the NR system. When the service type of the first communication apparatus is an NB-IoT type, the first mode includes an idle state and the first communication apparatus may have one or more of idle-state functions in the NR system, and the second mode includes an inactive state and/or a connected state and the first communication apparatus may have one or more of inactive-state functions and/or connected-state functions in the NR system. Alternatively, when the service type of the first communication apparatus is a URLLC type, the first mode includes an idle state and/or an inactive state and the first communication apparatus may have one or more of idle-state functions and/or inactive-state functions in the NR system, and the second mode includes a connected state and the first communication apparatus may have one or more of connected-state functions in the NR system. When the service type of the first communication apparatus is a CPE type, the first mode includes a first connected state and the first communication apparatus may have one or more of connected-state functions in the NR system, and the second mode includes a second connected state and the first communication apparatus may have one or more of connected-state functions in the NR system.

In this embodiment of this application, a specific correspondence between the mode and the service type is proposed for several common service types. According to the foregoing design, two different modes or two states may be defined for different terminal types. Compared with that in the three states in the NR system, signaling overheads for mode switching can be reduced, a function of a mode or a state can be user-defined, and energy saving of the communication apparatus can be performed as required.

In a possible implementation, the first signal may be an SRS, an SR, or a preamble sequence.

In this embodiment of this application, a plurality of possible implementations are proposed for the first signal, to improve implementability of the solution. In addition, different implementations are applicable to different scenarios, to meet communication requirements in different scenarios and reduce a delay.

In a possible implementation, the first signal includes identifier information of the first communication apparatus, so that the second communication apparatus can determine, based on the identifier information, the communication apparatus that sends the first signal.

In a possible implementation, the first signal is a dedicated mode switching request signal.

In this embodiment of this application, the first signal may be a dedicated mode switching request signal, and has features such as strong pertinence and flexible configuration. Therefore, resource overheads are reduced while a switching request is met.

In a possible implementation, there is a correspondence between a frame structure of the first signal and the service type of the first communication apparatus.

In this embodiment of this application, the frame structure is designed based on the service type of the first communication device, to implement frame structure customization, so that transmission requirements of first communication devices of different service types can be better met, and communication efficiency can be improved.

In a possible implementation, the second communication apparatus may send first response information to the first communication apparatus.

In this embodiment of this application, the second communication apparatus may send the first response information to the first communication apparatus, to indicate the first communication apparatus to perform mode switching based on the first response information. This enhances reliability of mode switching of the first communication apparatus. The first communication apparatus and the second communication apparatus have consistent definitions of the mode or the state.

In a possible implementation, the first response information includes DCI, an ACK, a NACK, or higher layer signaling.

In this embodiment of this application, a plurality of possible implementations are proposed for the first response information, to improve implementability of the solution. In addition, different implementations are applicable to different scenarios, to meet communication requirements in different scenarios.

In a possible implementation, the first signal may be used to request a group of communication apparatuses to perform mode switching, and the first communication apparatus is an apparatus in the foregoing group of communication apparatuses.

In this embodiment of this application, in the group of communication apparatuses, only the first communication apparatus sends a request. Compared with a case in which each communication apparatus sends a request signal, signal overheads can be reduced, energy saving of the communication apparatus can be implemented, and communication efficiency can be improved.

In a possible implementation, the second communication apparatus may send second response information to the first communication apparatus; or the second communication apparatus sends second response information to each communication apparatus in the group of communication apparatuses.

In this embodiment of this application, the second communication apparatus may send the second response information to the first communication apparatus, to enhance mode switching reliability. The second communication apparatus and the first communication apparatus have a consistent understanding of the mode or the state.

In this embodiment of this application, the second communication apparatus may indicate the third communication apparatus in the communication apparatus group in which the second communication apparatus is located to perform mode switching. The third communication apparatus may perform mode switching after receiving the mode switching indication of the second communication apparatus. To be specific, modes in the communication apparatus group may be consistent, so as to cooperatively complete data communication, thereby improving group communication efficiency.

In a possible implementation, the second response information may be DCI, an ACK, a NACK, or higher layer signaling.

In this embodiment of this application, the first response information and the second response information may be the same or may be different.

In this embodiment of this application, a plurality of possible implementations are proposed for the second response information, to improve implementability of the solution. In addition, different implementations are applicable to different scenarios, to meet communication requirements in different scenarios.

According to a third aspect, an embodiment of this application provides a communication apparatus. The apparatus may be used as a first communication apparatus, and the apparatus performs the method in any one of the first aspect or the implementations of the first aspect. The communication apparatus may be a terminal device, or may be an apparatus (for example, a chip, a chip system, or a circuit) in a terminal device or a network device, or may be an apparatus that can match the terminal device for use. In a possible implementation, the communication apparatus may include modules or units that one to one correspond to the methods/operations/steps/actions described in the first aspect. The modules or units may be hardware circuits, software, or may be implemented by a hardware circuit in combination with software. In a possible implementation, the apparatus includes a receiving unit and a switching unit.

A sending unit is configured to send a first signal to a second communication apparatus, where the first signal indicates that the communication apparatus requests to perform mode switching, a mode includes a first mode and a second mode, and there is a correspondence between the mode and a service type of the communication apparatus.

The switching unit is configured to switch a mode.

In a possible implementation, the first signal is a physical layer signal.

In a possible implementation, that there is a correspondence between the mode and a service type of the communication apparatus includes: when the service type of the communication apparatus is an enhanced mobile broadband eMBB type, the first mode includes an idle state and/or an inactive state, and the second mode includes a connected state; when the service type of the communication apparatus is an internet of things IoT type, the first mode includes an idle state, and the second mode includes an inactive state and/or a connected state; or when a service type of the communication apparatus is an ultra-reliable low-latency communication URLLC type, the first mode includes an idle state and/or an inactive state, and the second mode includes a connected state.

In a possible implementation, the first signal is a sounding reference signal SRS, a scheduling request SR, or a preamble sequence.

In a possible implementation, the first signal includes identifier information of the communication apparatus.

In a possible implementation, the first signal is a dedicated mode switching request signal.

In a possible implementation, there is a correspondence between a frame structure of the first signal and the service type of the communication apparatus.

In a possible implementation, the communication apparatus further includes a receiving unit, configured to receive first response information from the second communication apparatus.

That the switching unit is configured to switch the mode includes: the switching unit is configured to switch the mode based on the first response information.

In a possible implementation, the first signal is used to request a group of communication apparatuses to perform mode switching, and the communication apparatus is an apparatus in the group of communication apparatuses.

In a possible implementation, the receiving unit is further configured to receive second response information from the second communication apparatus; and the sending unit is further configured to send a mode switching indication to a third communication apparatus, where the third communication apparatus is an apparatus in the foregoing group of communication apparatuses.

In a possible implementation, the switching unit is further configured to: when the mode of the communication apparatus is the second mode, switch from the second mode to the first mode based on a timer.

It should be noted that, for beneficial effects of the implementations of the communication apparatus provided in the third aspect of embodiments of this application, refer to beneficial effects of the mode switching method according to the first aspect. Details are not described herein again.

According to a fourth aspect, an embodiment of this application provides a communication apparatus. The apparatus may be used as a second communication apparatus, and the apparatus performs the method in any one of the second aspect or the implementations of the second aspect. The communication apparatus may be an access network device or an apparatus (for example, a chip, a chip system, or a circuit) in the access network device, or an apparatus that can match the access network device for use. In a possible implementation, the communication apparatus may include modules or units that one to one correspond to the methods/operations/steps/actions described in the first aspect. The modules or units may be hardware circuits, software, or may be implemented by a hardware circuit in combination with software. In a possible implementation, the communication apparatus may include a processing unit and a receiving unit. The processing unit may be configured to invoke the transceiver unit to perform receiving and/or sending functions. An example is as follows.

The receiving unit is configured to receive a first signal, where the first signal indicates that a first communication apparatus requests to perform mode switching, a mode includes a first mode and a second mode, and there is a correspondence between the mode and a service type of the first communication apparatus.

The processing unit is configured to determine a mode of the first communication apparatus.

In a possible implementation, the first signal is a physical layer signal.

In a possible implementation, that there is a correspondence between the mode and a service type of the first communication apparatus includes: when the service type of the first communication apparatus is an enhanced mobile broadband eMBB type, the first mode includes an idle state and/or an inactive state, and the second mode includes a connected state; when the service type of the first communication apparatus is an internet of things IoT type, the first mode includes an idle state, and the second mode includes an inactive state and/or a connected state; or when the service type of the first communication apparatus is an ultra-reliable low-latency communication URLLC type, the first mode includes an idle state and/or an inactive state, and the second mode includes a connected state.

In a possible implementation, the first signal is a sounding reference signal SRS, a scheduling request SR, or a preamble sequence.

In a possible implementation, the first signal includes identifier information of the first communication apparatus.

In a possible implementation, the first signal is a dedicated mode switching request signal.

In a possible implementation, there is a correspondence between a frame structure of the first signal and the service type of the first communication apparatus.

In a possible implementation, the communication apparatus further includes a sending unit, configured to send first response information.

In a possible implementation, the first signal is used to request a group of communication apparatuses to perform mode switching, and the first communication apparatus is an apparatus in the group of communication apparatuses.

In a possible implementation, the sending unit is further configured to: send second response information to the first communication apparatus; or send second response information to each apparatus in the group of communication apparatuses.

It should be noted that, for beneficial effects of the implementations of the communication apparatus provided in the fourth aspect of embodiments of this application, refer to beneficial effects of the mode switching method according to the second aspect. Details are not described herein again.

According to a fifth aspect, this application provides a communication apparatus. The apparatus may be used as a first communication apparatus, and the apparatus has a function of implementing the method in the first aspect and the implementations of the first aspect. The apparatus includes a processor and a transmission interface. The transmission interface is configured to receive or send data. The processor is configured to call software instructions stored in a memory, to perform an information transmission method in the first aspect and the implementations of the first aspect.

According to a sixth aspect, this application provides a communication apparatus. The apparatus may be used as a second communication apparatus, and the apparatus has a function of implementing the method in the second aspect and the implementations of the second aspect. The apparatus includes a processor and a transmission interface. The transmission interface is configured to receive or send data. The processor is configured to call software instructions stored in a memory, to perform an information transmission method in the second aspect and the implementations of the second aspect.

According to a seventh aspect, this application provides a computer storage medium. The computer storage medium stores instructions, and when the instructions are executed on a computer, the computer is enabled to perform the method in the first aspect or the second aspect, and the implementations of the first aspect or the second aspect.

According to an eighth aspect, this application provides a computer program product. When the computer program product runs on a computer, the computer is enabled to perform the method in the first aspect or the second aspect and the implementations of the first aspect or the second aspect.

According to a ninth aspect, this application further provides a chip system. The chip system includes a processor, may further include a memory, and is configured to implement the method in the first aspect and any possible implementation of the first aspect, and the second aspect and any possible implementation of the second aspect. The chip system may include a chip, or may include a chip and another discrete component.

According to a tenth aspect, this application further provides a communication apparatus, including an input/output interface and a logic circuit. The input/output interface is configured to input or output a signal or data. The input/output interface is specifically configured to output the first signal. The logic circuit is configured to perform the method in the first aspect and any possible implementation of the first aspect to perform mode switching.

According to an eleventh aspect, this application further provides a communication apparatus, including an input/output interface and a logic circuit. The input/output interface is configured to input or output a signal or data. The input/output interface is specifically configured to obtain a first signal. The logic circuit is configured to perform the method in the second aspect and any possible implementation of the second aspect to determine a mode of the first communication apparatus.

According to a twelfth aspect, this application further provides a communication system, including the first communication apparatus and the second communication apparatus in the foregoing aspects.

### BRIEF DESCRIPTION OF DRAWINGS

FIG. 1 is a schematic diagram of a communication system according to an embodiment of this application;

FIG. 2 is a schematic diagram of an architecture of a network according to an embodiment of this application;

FIG. 3 is a schematic diagram of three states in the conventional technology;

FIG. 4 is a schematic flowchart of establishing a radio resource control RRC connection by a terminal device;

FIG. 5 is a schematic flowchart of random access;

FIG. 6 is a schematic flowchart of a mode switching method according to an embodiment of this application;

FIG. 7 is a sequence duration diagram of a PRACH according to an embodiment of this application;

FIG. 8 is a schematic diagram of a packet according to an embodiment of this application;

FIG. 9 is a schematic diagram of a packet of a group of terminal devices according to an embodiment of this application;

FIG. 10 is a schematic diagram of a packet of another group of terminal devices according to an embodiment of this application;

FIG. 11 is a schematic diagram of a packet of another group of terminal devices according to an embodiment of this application;

FIG. 12 is a schematic diagram of a mode switching procedure according to an embodiment of this application;

FIG. 13 is another schematic diagram of a mode switching procedure according to an embodiment of this application;

FIG. 14 is another schematic diagram of a mode switching procedure according to an embodiment of this application;

FIG. 15 is another schematic diagram of a mode switching procedure according to an embodiment of this application;

FIG. 16 is a schematic diagram of a structure of a first communication apparatus according to an embodiment of this application;

FIG. 17 is a schematic diagram of a structure of a second communication apparatus according to an embodiment of this application;

FIG. 18 is a schematic diagram of a structure of a terminal device according to an embodiment of this application;

FIG. 19 is a schematic diagram of a structure of an access network device according to an embodiment of this application; and

FIG. 20 is a schematic diagram of a structure of a core network device according to an embodiment of this application.

### DESCRIPTION OF EMBODIMENTS

Embodiments of this application provide a mode switching method, used by a terminal device to perform mode switching, to reduce a delay in performing mode switching by the terminal device.

The following describes the technical solutions in embodiments of this application with reference to the accompanying drawings in embodiments of this application. In this application, “at least one” means one or more, and “a plurality of” means two or more. The term “and/or” describes an association relationship between associated objects, and indicates that three relationships may exist. For example, A and/or B may indicate the following three cases: A exists alone, both A and B exist, and B exists alone, where A and B may be singular or plural. The character “/” generally indicates an “or” relationship between the associated objects. At least one of the following items (pieces) or a similar expression thereof indicates any combination of these items, including a single item (piece) or any combination of a plurality of items (pieces). For example, at least one of a, b, or c may represent: a, b, c, a and b, a and c, b and c, or a, b, and c, where a, b, and c may be singular or plural. It should be noted that “at least one item (piece)” may also be explained as “one item (piece) or more items (pieces)”.

It should be noted that, in this application, words “example” or “for example” are used to represent giving an example, an illustration, or a description. Any embodiment or design scheme described as an “example” or “for example” in this application should not be explained as being more preferred or having more advantages than another embodiment or design scheme. Exactly, use of the word such as “example” or “for example” is intended to present a relative concept in a specific manner.

Descriptions such as “first” and “second” in embodiments of this application are merely used for indicating and distinguishing between described objects, do not show a sequence, do not indicate a specific limitation on a quantity of devices in embodiments of this application, and cannot constitute any limitation on embodiments of this application.

The technical solutions provided in embodiments of this application may be applied to various communication systems, for example, a long term evolution (LTE) system, a 5th generation (5G) mobile communication system, a 6th generation (6G) mobile communication system, a wireless fidelity (Wi-Fi) system, a short-range communication system, a satellite communication system, an internet of vehicles communication system, a non-terrestrial communication system, a future communication system, or a system integrating a plurality of communication systems. This is not limited in this embodiment of this application. 5G may also be referred to as new radio (NR).

The technical solutions provided in embodiments of this application may be applied to various communication scenarios, for example, may be applied to one or more of the following communication scenarios: enhanced mobile broadband (eMBB), ultra-reliable low-latency communication (URLLC), machine type communication (MTC), massive machine type communication (mMTC), device-to-device (D2D), vehicle to everything (V2X), vehicle to vehicle (V2V), internet of things (IoT), virtual reality (VR), augmented reality (AR), a customer premise equipment (CPE), and a sensor.

This embodiment of this application is applicable to both a homogeneous network scenario and a heterogeneous network scenario, and is not limited to a transmission point. Coordinated multipoint transmission may be performed between macro base stations, between micro base stations, and between a macro base station and a micro base station. The embodiment of this application is applicable to a frequency division multiplexing system, a time division multiplexing system, a duplex system, an access and backhaul system, a relay system, and the like. The embodiment of this application is applicable to a low-frequency scenario (sub 6G), or a highfrequency scenario (above 6G), terahertz, optical communication, or the like.

Refer to FIG. 1. A network framework in an embodiment of this application includes an access network device 101 and a terminal device 102.

The access network device 101 is a radio access network (RAN) node (or device) that connects a terminal to a wireless network, and may also be referred to as a base station. Currently, examples of some RAN nodes are: a continuing evolved NodeB (gNB), a transmission reception point (TRP), an evolved NodeB (eNB)), a radio network controller (RNC), a home NodeB (for example, a home evolved NodeB, or a home NodeB, HNB), a wireless fidelity (Wi-Fi) access point (AP), a wireless relay node, a wireless backhaul node, a transmission point (TP), or a transmission reception point (TRP); and may also be one or a group of antenna panels of an ngNB, or a transmission point (TRP or TP), or a base station in a 5G system, for example, NR; or may be a network node forming a gNB or a transmission point, for example, a baseband unit (BBU), or a distributed unit (DU), a device that undertakes a function of a base station in a device-to-device (D2D) communication, a vehicle-to-everything (V2X) communication, or a machine-to-machine (M2M) communication, a base station in a future communication system, or the like.

In some deployments, the gNB may include a central unit (CU) and the DU, and the gNB may further include an active antenna unit (AAU). The CU implements some functions of the gNB, and the DU implements some functions of the gNB. For example, the CU is responsible for processing a non-real-time protocol and service, and implements functions of a radio resource control (RRC) layer and a packet data convergence protocol (PDCP) layer. The DU is responsible for processing a physical layer protocol and a real-time service, to implement functions of a radio link control (RLC) layer, a medium access control (MAC) layer, and a physical (PHY) layer. The AAU implements some physical layer processing functions, radio frequency processing, and a function related to an active antenna. Information at the RRC layer eventually becomes information at the PHY layer, or is changed from information at the PHY layer. Therefore, in this architecture, higher-layer signaling such as RRC layer signaling may also be considered as being sent by the DU or sent by the DU and the AAU. It may be understood that the network device may be a device including one or more of a CU node, a DU node, and an AAU node. In addition, the CU may be classified into a network device in an access network (RAN), or the CU may be classified into a network device in a core network (CN). This is not limited in this application.

The network device serves a cell, and the terminal device communicates with the cell by using a transmission resource (for example, a frequency domain resource or a spectrum resource) allocated by the network device. The cell may belong to a macro base station (for example, a macro eNB or a macro gNB), or may belong to a base station corresponding to a small cell. The small cell herein may include a metro cell, a micro cell, a pico cell, a femto cell, and the like. These small cells have characteristics of small coverage and low transmit power, and are applicable to providing a high-rate data transmission service.

The terminal device 102 is also be referred to as user equipment (UE), a mobile station (MS), a mobile terminal (MT), or the like, and is a device that provides a user with voice and/or data connectivity. For example, the terminal device 102 is a handheld device or a vehicle-mounted device that has a wireless connection function. The terminal device may also be briefly referred to as a terminal. Currently, some terminals are, for example, a mobile phone, a tablet computer, a notebook computer, a palmtop computer, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, a sensor, a cellular phone, a cordless phone, a session initiation protocol (SIP) phone, a wireless local loop (WLL) station, a personal digital assistant (PDA), a hand-held device or a computing device that has a wireless communication function or another processing device connected to a wireless modem, a vehicle-mounted device, a wearable device, a terminal device in a 5G network, and a terminal device in a future evolved public land mobile network (PLMN).

The wearable device may also be referred to as a wearable intelligent device, and is a general term of wearable devices, such as glasses, gloves, watches, clothes, and shoes, that are developed by applying wearable technologies to intelligent designs of daily wear. The wearable device is a portable device that can be directly worn on the body or integrated into clothes or an accessory of a user.

The wearable device is not only a hardware device, but also implements a powerful function through software support, data exchange, and cloud interaction. Generalized wearable intelligent devices include full-featured and large-size devices that can implement complete or partial functions without depending on smartphones, such as smart watches or smart glasses, and devices that focus on only one type of application function and need to work with other devices such as smartphones, such as various smart bands or smart jewelry for monitoring physical signs.

In addition, the terminal device may alternatively be a terminal device in an internet of things (IoT) system. An IoT is an important part in future development of information technologies. A main technical feature of the IoT is to connect things to a network by using a communication technology, to implement an intelligent network for human-machine interconnection and thing-thing interconnection. The IoT technology can implement massive connections, deep coverage, and power saving for terminals by using, for example, a narrow band (NB) technology.

In addition, the terminal device may alternatively include sensors such as an intelligent printer, a train detector, and a gas station, and main functions include: collecting data, receiving control information and downlink data of a network device, sending an electromagnetic wave, and transmitting uplink data to the network device.

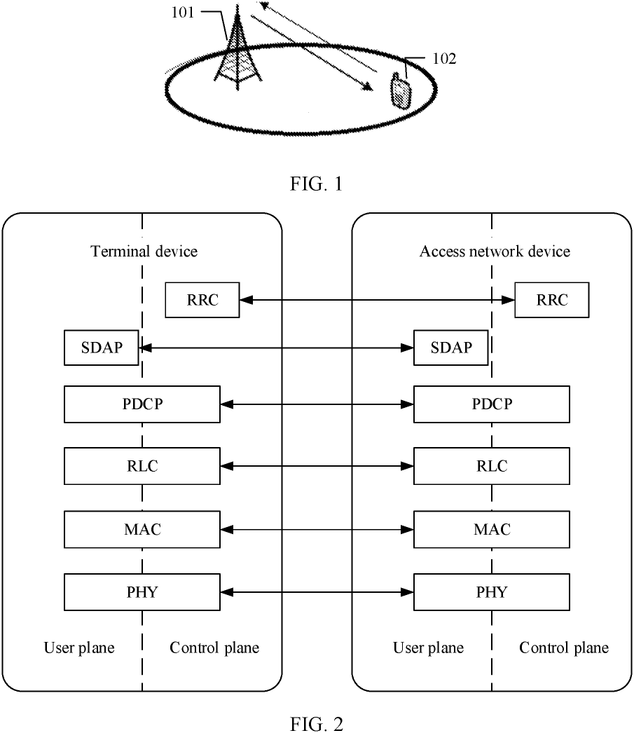

FIG. 2 is a schematic diagram of a network architecture according to an embodiment of this application. The network architecture may include a physical layer (PHY), a media access control (MAC) layer, a radio link control (radio link control, RLC) layer, a packet data convergence protocol (PDCP) layer, and a radio resource control (RRC) layer.

The terminal may include a user plane protocol and a control plane protocol, and the base station may include a user plane protocol and a control plane protocol. Layers of the terminal and the base station may be connected to each other to transmit information.

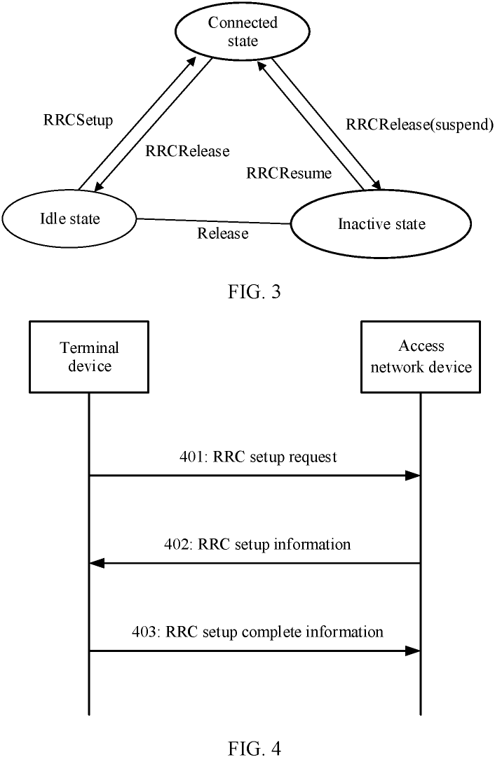

Refer to FIG. 3. NR defines three states: an idle state, an inactive state, and a connected state. A terminal device is in only one state at a moment.

A terminal device in the idle state cannot receive or send data. To receive or send data, the terminal device needs to enter the inactive state or the connected state. In the inactive state, only small packets can be received or sent.

With evolution and development of technologies, the terminal device may receive or send small-packet data in the inactive state. In the inactive state, the access network device may send an RRC configuration to the terminal device. For example, the RRC configuration may include terminal device capability reporting and configured grant. Alternatively, a random access channel (RACH) may be configured to perform uplink synchronization and uplink data transmission.

FIG. 4 is a schematic flowchart of establishing an RRC connection by a terminal device. Three higher layer signaling interaction steps are included.

401: A terminal device sends an RRC setup request to an access network device.

402: The access network device returns RRC setup information to the terminal.

403: The terminal device sends RRC setup complete information to the access network device.

In an NR system, if the terminal device is currently in an idle state, when the terminal device wants to switch from the idle state to a connected state, the terminal device needs to establish an RRC connection, that is, perform the foregoing RRC connection establishment procedure.

Refer to FIG. 2. For example, RRC signaling, MAC signaling, and RLC signaling are all higher layer signaling. Correspondingly, other signaling is physical layer (PHY) signaling.

The physical layer signaling may also be referred to as lower layer signaling.

The higher layer signaling in this application may be RRC signaling, MAC signaling, RLC signaling, or the like. The physical layer signaling may be DCI, data carried on a physical layer channel, or the like.

The RRC signaling belongs to higher layer signaling. Each piece of RRC signaling may need to be scheduled by a physical layer for receiving and sending, for example, receiving and/or sending DCI, and receiving and/or sending a data channel. Consequently, a transmission delay of the higher layer signaling is large, for example, ranging from tens of milliseconds (ms) to hundreds of milliseconds.

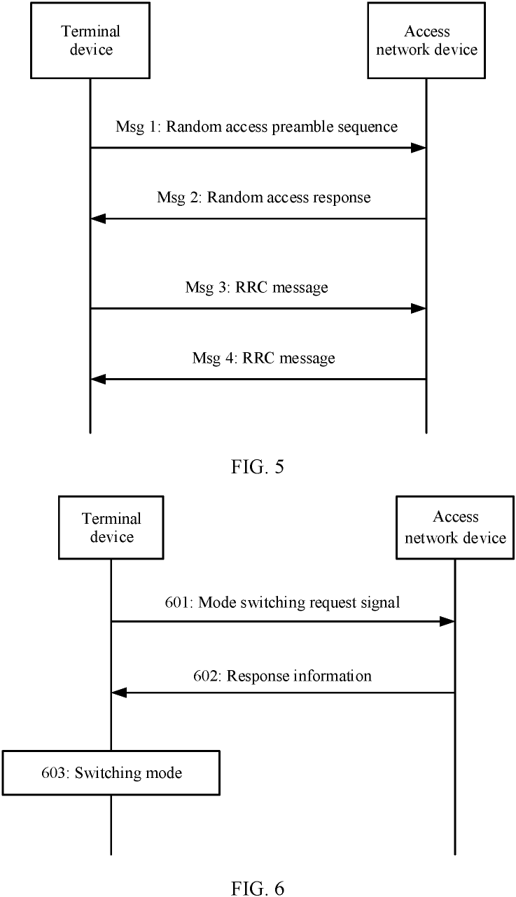

Refer to FIG. 5. In some cases, for example, when a terminal device switches from an idle state to an inactive state or a connected state, if the terminal device goes beyond an effective range of a timing advance value, or the terminal device enters an RRC connected state for the first time, the terminal device needs to initiate random access, that is, perform a random access procedure.

Specifically, the random access procedure may include the following four steps.

For example, step 1: The terminal device sends a random access preamble sequence. This may also be referred to as that the terminal device sends a message 1 (Msg 1).

Step 2: An access network device feeds back a random access response. This may also be referred to as that the access network device sends a message 2 (Msg 2). The random access response may carry a timing advance value. If the preamble sequence is not dedicated to the terminal device, step 3 is performed.

Step 3: The terminal device needs to send a message 3 (Msg 3), where the message 3 may be an RRC message (RRC signaling).

Step 4: The access network device sends a message 4 (Msg 4), where the message 4 may be the RRC message (RRC signaling).

Further, the message 4 may carry an identifier of the terminal device, so as to perform conflict resolution. In other words, the terminal device can enter the connected state only after four steps of random access are completed, and a delay is long.

A first communication apparatus in embodiments of this application may be a terminal device, an access network device, or another communication device, and a second communication apparatus may be a terminal device, an access network device, or another communication device.

The following embodiments are described by using an example in which the first communication apparatus is the terminal device and the second communication apparatus is the access network device.

To resolve the foregoing problem of a long delay, an embodiment of this application provides a mode switching method. This embodiment of this application may be used as an independent embodiment, or may be combined with another embodiment of this application. This is not specifically limited in this application. FIG. 6 is a schematic flowchart of a mode switching method according to an embodiment of this application. The method includes the following steps.

601: A terminal device sends a mode switching request signal to an access network device.

The mode switching request signal is used by the terminal device to request mode switching, for example, used to indicate that a mode of the terminal device changes. A mode may include a first mode and a second mode.

In a possible implementation, the mode switching request signal may be used by the terminal device to request to switch from the first mode to the second mode. For example, the mode switching request signal may also be used by the terminal device to request to send data, or request to enter an enhanced state, or request to switch from a default energy-saving mode to a data transmission mode.

In a possible implementation, the mode switching request signal may be used by the terminal device to request to switch from the second mode to the first mode. For example, the mode switching request signal may also be used by the terminal device to request to enter an energy-saving state, or request to stop sending data, or request to switch from the data transmission mode to the default energy-saving mode.

The mode switching request signal may also be referred to as a mode request signal for short. A state switching request signal may also be referred to as a state request signal for short.

The mode switching request signal may also be referred to as a mode switching request for short.

The mode switching signal or the state switching signal may also be referred to as a first signal or the like for short. A specific signal name is not limited in this embodiment of this application.

Alternatively, the mode in this embodiment of this application may be a state. The terminal device may have one or two modes (or states). To be specific, the terminal device in this embodiment of this application is in one state and two modes, or two states or two modes. Compared with three states, the terminal device and/or the access network device can reduce signaling overheads for mode switching, reduce switching complexity, and reduce a switching delay.

“One state and two modes” may mean that the terminal device may have two modes in a first state.

For example, the terminal device has only one state, that is, a first state. The first state may include a first state of an energy-saving mode and a first state of an enhanced mode, or the first state may include a first state in which no data is transmitted and a first state in which data is transmitted, or the first state may include a first state in which small-packet data is transmitted and a first state in which large-packet data is transmitted.

The first state may have one or more of idle-state functions and/or inactive-state functions and/or connected-state functions in an NR system.

For example, “one state and two modes” may mean that the terminal device may have two modes in a connected state.

For example, the terminal device has only one state, that is, a connected state. The connected state may include a connected state in an energy-saving mode and a connected state in an enhanced mode, or the connected state may include a connected state in which no data is transmitted and a connected state in which data is transmitted, or the connected state may include a connected state in which small-packet data is transmitted and a connected state in which large-packet data is transmitted.

For example, “one state and two modes” may mean that the terminal device may have two modes in an inactive state.

For example, the terminal device has only one state, that is, an inactive state. The inactive state may include an inactive state in an energy-saving mode and an inactive state in an enhanced mode, the connected state may include an inactive state in which no data is transmitted, and an inactive state in which data is transmitted, or the like.

In this embodiment, “one state and two modes” or “two modes” are used as an example for description. It may be understood that when the terminal device is in two states, the mode switching request signal may be a state switching request, and other related signaling in this embodiment may be converted in the same way. Details are not described herein again.

Mode switching or state switching may also refer to switching of a signal sending mode or switching of a signal sending state, or may refer to switching of a signal receiving mode or switching of a signal receiving state, or switching from the energy-saving mode to a high-efficiency data transmission mode, or switching from a high-efficiency data transmission mode to the energy-saving mode, or the like. Switching in this embodiment of this application may also be referred to as conversion. This is not specifically limited.

Optionally, switching in this embodiment of this application may also be referred to as conversion, and may have a same meaning.

The mode switching request signal in this application may be alternatively represented in a manner such as first information or a first signal, and the signal is used by the terminal device to request mode switching.

In this application, a mode or state switching method may be triggered by a first terminal device in a scenario that is for uplink data or in which the terminal device has a data sending request, or that is for downlink data or in which the access network device has a requirement for the terminal device to receive data.

The “two modes” in this embodiment may be an idle mode and a connected mode, a data transmission mode and a non-data transmission mode, a small-packet transmission mode and a large-packet transmission mode, or an energy-saving mode and a high-efficiency transmission mode.

It may be understood that the two modes may also be expressed in other manners. In this embodiment, a first mode and a second mode are used as examples for description, where the first mode is an idle mode/energy-saving mode, and the second mode is a connected mode/high-efficiency transmission mode.

Optionally, the mode or the state in this embodiment of this application may be an RRC state, or may be a state of the terminal device, or the like. This is not specifically limited herein. The state of the terminal device may be one or more of a data transmission state, an energy saving state, a power consumption state, and a capability state.

Optionally, the first mode may be a non-data transmission mode, and the second mode may be a data transmission mode.

Optionally, the first mode may be a small data packet transmission mode, and the second mode may be a large data packet transmission mode. A small packet and a large packet may be defined based on an amount of data. Alternatively, a mode in which a data packet for transmitting information is less than a preset bit threshold is defined as a small-packet mode, and a mode in which a data packet for transmitting information is not less than the preset bit threshold is defined as a large-packet transmission mode. The preset bit threshold may be 30 bits, 50 bits, 100 bits, or the like. A specific value is not limited herein. For example, when the amount of data is less than 100 bits, data is small-packet data. 100 is merely an example, and another value may also be used. This is not limited herein.

Optionally, the first mode may be a default mode, and the second mode may be an enhanced mode.

Optionally, the first mode may be a default energy-saving mode, and the second mode may be an enhanced communication mode.

Optionally, the first mode may be a connected state in the default energy-saving mode, and the second mode may be a connected state in the enhanced communication mode.

Alternatively, the mode or the state may be another example. This is not specifically limited in this application.

Optionally, when the first communication apparatus is in a service type, the first communication apparatus communicates with the second communication apparatus, and the first communication apparatus may communicate different content in different modes. To better adapt to communication in different communication content, the first notification apparatus may perform mode switching.

Optionally, in different service types, standards for determining whether the first communication apparatus is in the first mode or the second mode may be different, and the first communication apparatus may communicate different content in different service types.

To better adapt to communication under communication content of different service types, the first communication apparatus may perform mode switching. For example, when the first communication device switches a service type, the first communication apparatus may send a mode switching request signal to the second communication apparatus, and switch a mode.

For example, the first communication device may include two service types. For example, when the service type of the first communication device is switched from an eMBB type to a URLLC type, the first communication apparatus may send the mode switching request signal to the second communication apparatus. For example, when the service type of the first communication device is converted from a URLLC type to a V2X type, the first communication apparatus may send the mode switching request signal to the second communication apparatus.

For example, when the service type of the first communication device is converted from an eMBB type to a V2X type, the first communication apparatus may send the mode switching request signal to the second communication apparatus.

The mode switching request signal belongs to physical layer signaling, and the physical layer signaling has a low transmission delay compared with higher layer signaling.

In this embodiment, mode or state switching is implemented by using the physical layer signaling, so that signaling overheads can be reduced, a switching delay can be reduced, and energy saving can be implemented.

The service type of the first communication apparatus may be defined in a plurality of manners, and may be defined based on a data packet size, a data transmission delay reliability requirement, mobility, a transmission delay requirement, a channel environment, a reliability requirement, a coverage requirement, a communication scenario, or the like when the first communication apparatus and the second communication apparatus perform data transmission. This is not specifically limited herein.

In a communication system, there may be a plurality of mainstream service types, for example, one or more of a terminal of an enhanced mobile broadband service type, a terminal of an internet of things service type, a terminal of an ultra-reliable low-latency communication service type, a terminal of a customer premise equipment type, a terminal of an augmented reality service type, a terminal of a virtual reality service type, and an internet of vehicles terminal.

For example, an eMBB service is mainly characterized by big data, and occasionally has small data, a user (or a terminal) is generally mobile, and requirements on a latency and reliability are low. Data is transmitted on both an uplink and a downlink, and a channel environment is complex and changeable, for example, an outdoor environment or an indoor environment.

For example, a URLLC service is mainly characterized by small data, and a terminal is usually non-mobile or has a fixed route. For example, in a factory scenario, requirements on a latency and reliability are high, and a channel environment is stable.

For example, an NB-IoT service is usually characterized by small data. The data may exist periodically, a terminal is not-mobile or moves at a high speed, for example, a smart water meter. More data is transmitted on an uplink and a channel environment is stable.

For example, a CPE service is usually characterized by big data, a terminal device is non-mobile and performs short-distance communication. Requirements on a latency and reliability are average, and a channel environment is stable.

With reference to three existing states (an idle state, an inactive state, and a connected state), in this embodiment of this application, a mode may be defined based on the service type of the terminal device. The following uses an example for description.

The following embodiment provides a mode design method that a mode can be designed based on the service type of the terminal device, so that modes can be user-defined, energy saving of the terminal device can be implemented, and communication efficiency can be improved while meeting a communication requirement of a service type of each terminal device. This embodiment of this application may be used as an independent embodiment, or may be combined with another embodiment of this application. This is not specifically limited in this application.

In a possible implementation, the mode is defined based on the service type of the terminal device. This embodiment of this application may be an independent embodiment, or may be combined with another embodiment of this application. This is not specifically limited in this application.

Optionally, there is a correspondence between the service type of the terminal device and the mode. The terminal device and/or the access network device may determine the mode based on the correspondence.

The following is a specific example of the correspondence between the mode and the service type.

1. The terminal device is a terminal device of an internet of things (IoT) service. A first mode of the terminal device is an idle state, and a second mode of the terminal device is an inactive state or a connected state.

The IoT terminal device may have features such as wide coverage, a large quantity of connections, a low rate, low costs, low power consumption, and an excellent architecture, for example, massive connections, lower power consumption, and lower chip costs. The IoT terminal may be a smart water meter, smart parking, smart pet tracking, a smart bicycle, a smart smoke detector, a smart toilet, a smart vending machine, or the like.

According to the foregoing design, when the IoT-type terminal device transmits small-packet data, energy can be saved as much as possible, and communication efficiency can be improved. In addition, a service of this type of terminal device is regular, and the terminal device may be in the idle state when there is no data according to the rule, to save energy as much as possible. When there is data, the terminal device is switched to the inactive state or the connected state, to complete data transmission. This reduces a switching delay, avoids frequent switching, and improves communication efficiency.

For example, the IoT service may include a narrowband internet of things (NB-IoT) service, a machine type communication (MTC) service, another internet of things service, or the like.

The MTC terminal features low costs and enhanced coverage. A large-scale internet of things services (mMTC) may also be included. The MTC terminal may be used in the following scenarios and applications: industrial application and control, traffic safety and control, remote manufacturing, remote training, remote surgery, and the like.

2. The terminal device is a terminal device of an enhanced mobile broadband (eMBB) service.

The first mode of the terminal device is the idle state or the inactive state, and the second mode is the connected state.

The eMBB may refer to further improvement of performance such as user experience based on an existing mobile broadband service scenario, and is also an application scenario closest to daily life of a user. In an eMBB scenario, a network speed is greatly improved. For example, even for a 4K HD video, a peak value can reach 10 Gbit/s.

According to the foregoing design, when the eMBB-type terminal device implements data transmission, energy can be saved as much as possible, and communication efficiency can be improved. In addition, a service of this type of terminal device is regular. According to the rule, when there is no data transmission or there is small-packet data transmission, the terminal device may be in the inactive state, to save energy as much as possible. When there is large-packet data transmission, the terminal device may switch to the connected state, to complete data transmission. This reduces a switching delay, avoids frequent switching, and improves communication efficiency.

3. The terminal device is a terminal device of an ultra-reliable low-latency communication (URLLC) service.

The first mode of the terminal device is the idle state, and the second mode is the inactive state.

Alternatively, the first mode of the terminal device is the inactive state, and the second mode is the connected state.

The URLLC terminal features high reliability, low latency, and very high availability. The URLLC terminal is used in the following scenarios and applications: industrial application and control, traffic safety and control, remote manufacturing, remote training, remote surgery, and the like. The URLLC has great potential in unmanned driving services. In addition, the URLLC is also very important for the security industry. The URLLC terminal may be a terminal device that has services, such as unmanned driving or industrial automation that requires a low-latency high-reliable connection, or the like.

According to the foregoing design, when the URLLC terminal device implements data transmission, energy can be saved as much as possible, and communication efficiency can be improved. In addition, when an amount of data of the services of the type of terminal device is small, according to this rule, when there is no data transmission, the terminal device may be in the idle state, to save energy as much as possible. When there is small-packet data transmission, the terminal device may switch to the inactive state to complete data transmission. This reduces a switching delay, avoids frequent switching, and improves communication efficiency. Alternatively, when the services are frequent, when there may be small-packet data transmission, the terminal device may be in the inactive state, to save energy as much as possible. When there is large-packet data transmission, the terminal device may switch to the connected state, to complete data transmission. This reduces a switching delay, avoids frequent switching, and improves communication efficiency. Specifically, the two modes may be properly configured based on a service state of the terminal of this type, so as to reduce energy consumption and improve communication efficiency while implementing service transmission.

4. The terminal device is a terminal of a customer premise equipment (CPE) type, a terminal of an augmented reality (AR) type, a terminal of a virtual reality (VR) type, or an internet of vehicles (V2X) terminal.

The first mode of the terminal device is a first connected state, and the second mode is a second connected state.

The first connected state is a low-power connected state, and the terminal device can save energy as much as possible. When there is large-packet data transmission, the terminal device may switch to the second connected state. The connected state is a high-rate connected state.

Alternatively, the first connected state may be a low-power connected state, a low-rate connected state, or the like, and the second connected state may be a high-power connected state, a high-rate connected state, or the like. This is not specifically limited herein.

The CPE may be a mobile signal access device that receives a mobile signal and forwards the mobile signal by using a wireless Wi-Fi signal. The CPE is also a device that converts a high-speed 4G or 5G signal into a Wi-Fi signal, and can support a large quantity of mobile terminals that can access the internet at the same time. The CPE can be widely used in rural areas, towns, hospitals, organizations, factories, and residential communities to provide wireless network access, reducing costs of wired network deployment.

The V2X is a key technology for an intelligent transportation system. It implements communication between a vehicle and a vehicle, between a vehicle and a base station, and between a base station and a base station. In this way, a series of traffic information such as a real-time road condition, road information, and pedestrian information can be obtained. This improves driving safety, reduces congestion, improves traffic efficiency, provides in-vehicle infotainment information, and the like.

According to the foregoing design, when the foregoing types of terminal devices implement data transmission, energy can be saved as much as possible, and communication efficiency can be improved. In addition, services of the type of terminal device are regular, and data is frequent. According to the rule, when there is no data transmission or there is small-packet data transmission, the terminal device may be in the first connected state, and the connected state is a low-power connected state, to save energy as much as possible. When there is large-packet data transmission, the terminal device may switch to the second connected state, and the connected state is a high-rate connected state, to quickly complete data transmission. This reduces a switching delay, avoids frequent switching, and improves communication efficiency.

The service type of the terminal device may include but is not limited to one or more of the following: eMBB, URLLC, MTC, NB-IoT, CPE, AV, VR, V2X, and the like.

The service type of the terminal device may also be referred to as a terminal type.

In the foregoing embodiment, the first mode is an idle state, an inactive state, or a connected state, and the second mode is an idle state, an inactive state, or a connected state. This is merely an example. Specifically, names of the first mode and/or the second mode may not be limited to the idle state, the inactive state, or the connected state. This is not specifically limited in this application.

That is, different first modes or first states, and/or different second modes or second states may be defined for different service types or terminal types.

Each mode or state may have its own function or an operation that needs to be performed. The function or the operation may be at least one of a function in the idle state, a function in the inactive state, and a function in the connected state that are included in the conventional technology.

Optionally, the first mode or the second mode may have one or more of the following functions of the idle state, the inactive state, or the connected state.

The foregoing describes mode division of terminal devices of different service types. The following separately describes functions of three states (the idle state, the inactive state, and the connected state).

### 1. Idle State

The terminal device may receive system information, a paging message, and cell selection or re-selection. To be specific, the terminal device may maintain only a basic link to a network, but the terminal device does not establish an RRC link to the access network device. Specific functions of the terminal device in the idle state include one or more of the following:

(A) The terminal device may receive terminal device-level discontinuous reception (DRX) configured by an upper layer device, for example, the access network device.

(B) The terminal device performs mobility control based on a network configuration.

(C) The terminal device may detect an SMS message, where the SMS message is a message scheduled and transmitted by using DCI scrambled by using a paging radio network temporary identifier (P-RNTI).

(D) The terminal device may detect a paging channel, for example, core network paging performed by using a 5G S-temporary mobile subscription identifier (5G-S-TMSI).

(E) The terminal device may perform neighboring cell measurement and cell selection or re-selection.

(F) Obtaining system information, and transmitting a system information request.

(G) The terminal device performs logging of a possible measurement and logging of a location and a time of the logged measurement configured by the terminal device.

### 2. Inactive State

The terminal device may receive system information, a paging message, and cell selection or re-selection, and may store context of the terminal device. In other words, the terminal device may maintain a basic link to a network, but the terminal device cannot transmit and/or receive a large amount of data. When the terminal device is in the inactive state, specific functions include one or more of the following:

(A) The terminal device may receive terminal device-level discontinuous reception (DRX) configured by an upper layer.

(B) Mobility controlled by the terminal device is based on a network configuration.

(C) The terminal device may store access stratum context when the terminal device is in the inactive state.

(D) The terminal device receives a message in a RAN notification area configured at an RRC layer.

(E) The terminal device may detect an SMS message, where the SMS message is a message scheduled and transmitted by using DCI scrambled by using a P-RNTI.

(F) The terminal device may detect a paging channel, perform core network paging by using a 5G-S-TMSI, and perform RAN paging by using a full inactive-radio network temporary identifier (full I-RNTI).

(G) The terminal device may perform neighboring cell measurement and cell selection or re-selection.

(H) The terminal device performs RAN-based periodic notification area update when moving outside a configured RAN-based notification area.

(I) Obtaining system information, and transmitting a system information request.

(G) Performing logging of a possible measurement, and logging of a location and a time of the logged measurement configured by the terminal device.

### 3. Connected State

There is an RRC link between the terminal device and the access network device, and the terminal device may transmit and/or receive data. When the terminal device is in the connected state, specific functions include one or more of the following:

(A) The terminal device stores access stratum context.

(B) The terminal device receives and/or sends unicast data.

(C) The terminal device may receive terminal device-level DRX configured by a lower-layer device, for example, the terminal device.

(D) For a terminal device that supports carrier aggregation (CA), the terminal device may receive data transmitted by a primary cell by aggregating one or more secondary cells, to enhance bandwidth.

(E) For a terminal device that supports dual connectivity (DC), the dual connectivity is used for a master cell group to aggregate one secondary cell group for bandwidth enhancement.

(F) The terminal device performs network-controlled mobility management.

(G) The terminal device may detect an SMS message, where the SMS message may be a message scheduled and transmitted by using DCI scrambled by using a P-RNTI.

(H) The terminal device may detect a control channel and an associated shared data channel.

(I) The terminal device may provide channel quality and feedback information.

(G) The terminal device may perform neighboring cell measurement and measurement reporting.

(K) Obtaining system information.

Optionally, to implement fast mode switching, the terminal device and/or the access network device may store/maintain two sets of RRC configurations, for example, an RRC configuration of the first mode and an RRC configuration of the second mode.

In a possible implementation, when the terminal device receives the RRC configuration that is of the first mode and that is sent by the access network device, the terminal device saves/maintains the RRC configuration of the first mode. When the terminal device switches from the first mode to the second mode for the first time, the access network device may send the RRC configuration of the second mode to the terminal device. In this case, the terminal device stores/maintains the RRC configuration of the first mode and the RRC configuration of the second mode. After the terminal device switches from the second mode to the first mode, the terminal device in the first mode may save/maintain the RRC configuration of the first mode and the RRC configuration of the second mode; or after the terminal device switches from the first mode to the second mode, the terminal device in the second mode may save/maintain the RRC configuration of the first mode and the RRC configuration of the second mode.

Based on the foregoing design, when the terminal device switches from the first mode to the second mode, or the terminal device switches from the second mode to the first mode, only one piece of mode switching indication information or mode switching request information is required to complete mode switching, and the access network device does not need to send the RRC configuration again, and the terminal device does not need to receive the RRC configuration. This reduces signaling overheads and a delay of mode switching, and improves communication efficiency.

In a possible implementation, when the terminal device is in the first mode, the access network device may send the RRC configuration of the first mode and the RRC configuration of the second mode to the terminal device, and the terminal device stores/maintains the RRC configuration of the first mode and the RRC configuration of the second mode. Alternatively, when the terminal device is in the second mode, the access network device may send the RRC configuration of the first mode and the RRC configuration of the second mode to the terminal device, and the terminal device stores/maintains the RRC configuration of the first mode and the RRC configuration of the second mode.

Based on the foregoing design, when the terminal device switches from the first mode to the second mode, or the terminal device switches from the second mode to the first mode, only one piece of mode switching indication information or mode switching request information is required to complete mode switching, and the access network device does not need to send the RRC configuration again, and the terminal device does not need to receive the RRC configuration. This reduces signaling overheads and a delay of mode switching, and improves communication efficiency.

Optionally, there is a correspondence between the mode and the service type of the first communication apparatus. This embodiment of this application may be an independent embodiment, or may be combined with another embodiment of this application. This is not specifically limited in this application.

The correspondence or mapping is predefined in a protocol, or may be configured by the access network device or the core network device for the terminal device by using signaling. This is not specifically limited herein.

Table 1 is an example of the correspondence between the terminal type and the mode. At least one row or at least one column in the table may be used as a correspondence. Table 1 uses a row as an example.

TABLE 1

| | | |
|---|---|---|
| Terminal type | First mode | Second mode |
| Terminal type 1 | Mode 11 | Mode 12 |
| Terminal type 2 | Mode 21 | Mode 22 |
| ... | ... | ... |
| Terminal type m | Mode m1 | Mode m2 |

m is a positive integer. The terminal type 1 to the terminal type m may be at least one of the following: a terminal of an eMBB service type, a terminal of a URLLC service type, a terminal of an IoT service type, a terminal of a CPE service type, a terminal of a V2X service type, a terminal of an AR/VR service type, and the like.

The mode 11 to the mode m1 and the mode 12 to the mode m2 may be one or more of the modes or states described in this application, or may be not limited to the modes or states described in this application.

The following is an example of the correspondence.

When the service type of the first communication apparatus is an enhanced mobile broadband eMBB type, the first mode includes an idle state and/or an inactive state and the first communication apparatus may have one or more of idle-state functions and/or inactive-state functions in an NR system, and the second mode includes a connected state and the first communication apparatus may have one or more of connected-state functions in the NR system; and/or
when the service type of the first communication apparatus is an internet of things IoT type, the first mode includes an idle state and the first communication apparatus may have one or more of idle-state functions in the NR system, and the second mode includes an inactive state and/or a connected state and the first communication apparatus may have one or more of inactive-state functions and/or connected-state functions in the NR system; and/or
when the service type of the first communication apparatus is an ultra-reliable low-latency communication URLLC type, the first mode includes an idle state and/or an inactive state and the first communication apparatus may have one or more of idle-state functions and/or inactive-state functions in the NR system, and the second mode includes a connected state and the first communication apparatus may have one or more of connected-state functions in the NR system; and/or
when the service type of the first communication apparatus is the CPE type, the first mode includes the first connected state and the first communication apparatus may have one or more of existing connected-state functions in NR, and the second mode includes the second connected state and the first communication apparatus may have one or more of connected-state functions in the NR system.

For example, for the IoT-type terminal device, the first mode or the first state may be the idle state, and the second mode or the second state may be the inactive state or the connected state. For example, the first mode or the first state has no data receiving and sending function, and may receive a paging message scheduled by using downlink control information scrambled by using a P-RNTI.

For example, for the eMBB-type terminal device, the first mode or the first state may be the inactive state, and the second mode or the second state may be the connected state. For example, the first mode or the first state has a data receiving and sending function, and may receive downlink control information scrambled by a cell radio network temporary identifier (C-RNTI), and perform data receiving and sending.

For example, for the URLLC-type terminal device, the first mode or the first state may be the idle state, and the second mode or the second state may be the inactive state. For example, the second mode or the second state has a data receiving and sending function, and may receive downlink control information scrambled by using a C-RNTI, and perform data receiving and sending.

For example, for the CPE-type terminal device, the first mode or the first state may be the first connected state, and the second mode or the second state may be the second connected state. For example, the first mode or the first state has a data receiving and sending function, and may receive downlink control information scrambled by using the C-RNTI, and perform data receiving and sending.

According to the foregoing design, different “one state and two modes” or different “two states” may be defined for different terminal types. Compared with that in existing three states, signaling overheads for mode switching can be reduced, a function of a mode or a state can be user-defined, and energy saving of the terminal device can be performed as required.

The first mode and the second mode may be one or more states of the idle state, the inactive state, and the connected state, or may be any one of a data transmission mode, a non-data transmission mode, a high-efficiency mode, an energy-saving mode, a small-packet transmission mode, a large-packet transmission mode, an energy-saving mode, a high-efficiency transmission mode, and the like. The first mode and the second mode may implement one or more of idle-state functions, inactive-state functions, and connected-state functions.

In this embodiment of this application, a specific signal form of the mode switching request signal is not limited. For example, the mode switching request signal may be a sounding reference signal (SRS), a scheduling request (SR), a preamble sequence, or a defined dedicated signal.

The mode switching request signal is an uplink signal or an uplink sequence. Alternatively, the mode switching request signal is a signal sent by the terminal device.

The following separately describes different signal forms. Specifically, the mode switching request signal may be one or more of the following forms or manners:

Manner 1.1: The mode switching request signal is the SRS.

When the terminal has completed uplink synchronization in the first mode, or has determined/obtained a timing advance value, the terminal may send the SRS based on the timing advance value.

For example, the terminal device may roughly estimate a maximum timing advance (TA) value of the terminal device based on positioning or a time path through empirical learning or machine learning, and send an uplink sequence or an uplink signal based on the TA value. The terminal device may avoid sending an uplink sequence or an uplink signal on a physical random access channel (PRACH) for a long time. (A shortest time of sending information on the PRACH is about 1 ms, and a longer time of sending information on the PRACH is about 4 ms.) Further, fast uplink synchronization access and mode switching can be implemented.

A resource for sending a mode or state switching request signal may be an uplink transmission resource. The resource may include at least one of a time domain resource, a frequency domain resource, a sequence, and a code resource.

Optionally, the uplink transmission resource may be configured by the access network device by using higher layer signaling, for example, RRC signaling or MAC signaling, or may be predefined, or may be notified by the access network device by using physical layer signaling, for example, indicated in DCI. This is not specifically limited in this embodiment of this application.

Optionally, the access network device may send configuration information of the mode switching request signal, where the configuration information indicates at least one of a time domain resource, a frequency domain resource, a sequence corresponding to a signal, and a code resource of the mode switching request signal.

When detecting the mode switching request signal, the access network device may determine that the terminal device requests mode switching.

Manner 1.2: The mode switching request signal is an SR.

When the terminal has completed uplink synchronization in the first mode, or has determined/obtained a timing advance value, the terminal may send the SR based on the timing advance value.

For example, the terminal device may roughly estimate a maximum TA value of the terminal device based on positioning or a time path through empirical learning or machine learning, and send an uplink sequence or an uplink signal based on the TA value. The terminal device may avoid sending an uplink sequence or an uplink signal on a PRACH for a long time. (A shortest time of sending information on the PRACH is about 1 ms, and a longer time of sending information on the PRACH is about 4 ms.) Further, fast uplink synchronization access and mode switching can be implemented.

In a feasible implementation, if the terminal device sends the SR to the access network device, it indicates that the terminal device requests mode switching.

Alternatively, if a value of data bearer included in the SR information is greater than or equal to (greater than) X1, it indicates that the terminal device requests mode switching. For example, the terminal device switches from the first mode to the second mode, or the terminal device switches from the second mode to the first mode.

Alternatively, if the value of the data bearer included in the SR information is less than (less than or equal to) X2, it indicates that the terminal device requests mode switching. For example, the terminal device switches from the first mode to the second mode, or the terminal device switches from the second mode to the first mode.

Both X1 and X2 are positive integers.

A resource used for sending the mode or state switching request signal may be an uplink transmission resource. The resource may include at least one of a time domain resource, a frequency domain resource, a sequence, and a code resource.

Optionally, the uplink transmission resource may be configured by the access network device by using higher layer signaling, for example, RRC signaling or MAC signaling, or may be predefined, or may be notified by the access network device by using physical layer signaling, for example, indicated in DCI. This is not specifically limited in this embodiment of this application.

Optionally, the access network device may send configuration information of the mode switching request signal, where the configuration information indicates at least one of a time domain resource, a frequency domain resource, a sequence, and a code resource of the mode switching request signal.

When detecting the mode switching request signal, the access network device may determine that the terminal device expects to perform mode switching.

Manner 1.3: The mode switching request signal is a preamble sequence.

When the terminal has completed uplink synchronization in the first mode, or has determined/obtained a timing advance value, the terminal may send the random access preamble sequence based on the timing advance value.

In this application, only one operation is required for sending the preamble sequence, and a multi-step random access procedure in the conventional technology does not need to be performed. Therefore, a delay can be reduced, overheads can be reduced, and communication efficiency can be improved.

A resource for sending a mode or state switching request signal may be an uplink transmission resource. The resource may include at least one of a time domain resource, a frequency domain resource, a sequence, and a code resource.

Optionally, the uplink transmission resource may be configured by the access network device by using higher layer signaling, for example, RRC signaling or MAC signaling, or may be predefined, or may be notified by the access network device by using physical layer signaling, for example, indicated in DCI. This is not specifically limited in this embodiment of this application.

Optionally, the access network device may send configuration information of the mode switching request signal, where the configuration information indicates at least one of a time domain resource, a frequency domain resource, a sequence, and a code resource of the mode switching request signal.

When detecting the mode switching request signal, the access network device may determine that the terminal device requests mode switching.

Manner 1.4: The mode switching request signal is a defined dedicated signal.

In addition to an existing signal, the mode switching request signal may also be a defined special signal, that is, the dedicated signal. The dedicated signal is a signal used for the mode switching request.

For example, the terminal device may roughly estimate a TA value of the terminal device based on positioning or a time path through empirical learning or machine learning, and send the mode switching request signal based on the TA value, to avoid sending a PRACH for a long time. Further, fast uplink synchronization access and mode switching can be implemented. The mode switching request signal may be located in a first symbol or first several symbols of a slot.

The following embodiment provides a frame structure design method. In the method, a frame structure is designed based on a service type of a terminal device, to implement frame structure customization, so that transmission requirements of different terminal devices can be better met, and communication efficiency can be improved. This embodiment of this application may be used as an independent embodiment, or may be combined with another embodiment of this application. This is not specifically limited in this application.

In a possible implementation, there is a correspondence between a frame structure of a signal and a service type of a terminal device. This embodiment of this application may be an independent embodiment, or may be combined with another embodiment of this application. This is not specifically limited in this application.

Specifically, for example, there is a correspondence between the frame structure of the mode switching request signal and the service type of the terminal device.

Optionally, frame structures of terminal devices of different service types may be different. The frame structure may include one or more of a cyclic prefix (CP) length, a subcarrier spacing, a symbol length, symbol duration, a slot length, slot duration, a time unit length, time unit duration, and the like. This is not specifically limited herein.

The following uses a CP length as an example for specific description. Other frame structures are similar, and details are not described again.

A cyclic prefix CP length of the mode switching request signal may be longer than an extended CP length in the NR protocol, and shorter than a CP length of a PRACH in the NR protocol. For example, the mode switching request signal is an SRS signal with a CP length longer than the length of the extended CP, or a preamble sequence with a CP length shorter than the length of the PRACH. In a possible implementation, the CP length of the mode switching request signal may be predefined in a protocol.

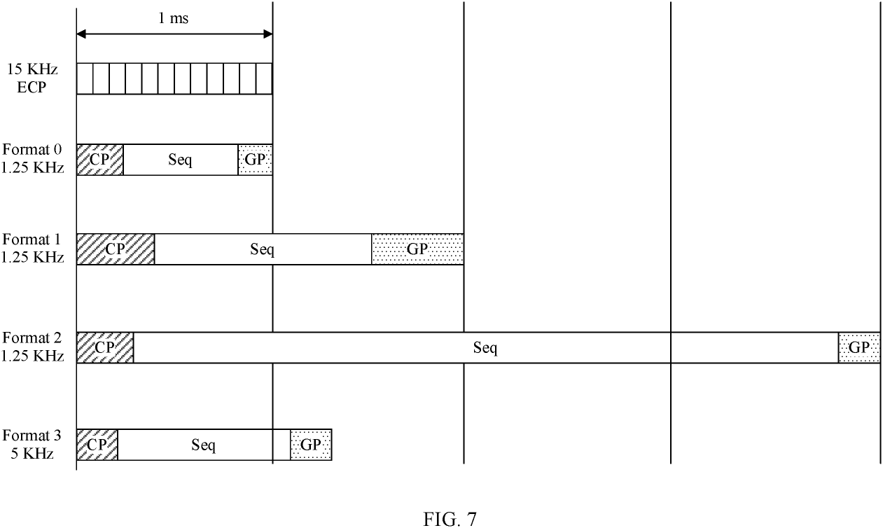

In the NR protocol, a length of a normal CP at 15 kilohertz kHz is 5.2 microseconds (µs), and a length of an extended CP is 16.67 µs. A sequence of a PRACH is shown in Table 2. A diagram of sequence duration of the PRACH is shown in FIG. 7, where Ts represents a basic time unit, 1 Ts = 1/30720 µs, for example, 3168 Ts ≈ 103 µs, and 21024 Ts ≈ 684 µs.

It can be learned that existing PRACH duration is 1 ms at the shortest and 4 ms at the longest, and the duration is long.

TABLE 2

| Format Format | SCS (kHz) Subcarrier spacing | BW (MHz) Bandwidth | OFDM symbols Symbol | T_SEQ (Ts) Sequence length | T_CP (Ts) CP length | T_GP (Ts) GP length | Use case Application scenario |
|---|---|---|---|---|---|---|---|
| 0 | 1.25 | 1.08 | 1 | 24576 | 3168 | 2975 | LTE reconstruction |
| 1 | 1.25 | 1.08 | 2 | 2*24576 | 21024 | 21904 | Cell whose radius is greater than 100 km |

| Format Format | SCS (kHz) Subcarrier spacing | BW (MHz) Bandwidth | OFDM symbols Symbol | T_SEQ (Ts) Sequence length | T_CP (Ts) CP length | T_GP (Ts) GP length | Use case Application scenario |
|---|---|---|---|---|---|---|---|
| 2 | 1.25 | 1.08 | 4 | 4*24576 | 4688 | 4528 | Coverage enhancement scenario |
| 3 | 5 | 4.32 | 4 | 4*6144 | 3168 | 2976 | High-speed scenario |

In a future communication system such as a 5G communication system or a 6G communication system, a distance between a terminal device and an access network device may be short, for example, in a factory scenario. Therefore, a short CP length may be used.

For example, the CP length of the mode switching request signal may range from 20 µs to 100 µs, for example, 23.33 µs, 30 µs, 43.35 µs, 50 µs, 63.36 µs, 70 µs, or 83.37 µs.

For example, the CP length of the mode switching request signal may range from 512 Ts to 3168 Ts, for example, 717 Ts, 921 Ts, 1332 Ts, 1536 Ts, 1946 Ts, 2150 Ts, or 2561 Ts.

For example, a distance between the terminal device and the access network device is within a radius of 1 km.

$${\text{T}}_{\text{CP}} \geq \frac{2 ∗ {10}^{3}}{3 ∗ {10}^{8}} + 16.67 ∗ {10}^{- 6} = \left(6.67 + 16.67\right) μ \text{} \text{s} = \text{23} \text{.33} μ \text{} \text{s} \text{.}$$

For example, a distance between the terminal device and the access network device is within a radius of 5 kms.

$${\text{T}}_{\text{CP}} \geq \frac{10 ∗ {10}^{3}}{3 ∗ {10}^{8}} + 16.67 ∗ {10}^{- 6} = \left(33.35 + 16.67\right) μ \text{} \text{s} = 50. \text{02} μ \text{} \text{s} \text{.}$$

For example, a distance between the terminal device and the access network device is within a radius of R kms.

$${\text{T}}_{\text{CP}} \geq \frac{2 ∗ \text{R} ∗ {10}^{3}}{3 ∗ {10}^{8}} + 16.67 ∗ {10}^{- 6} = \left(6.67 \text{*R} + 16.67\right) μ \text{} \text{s} \text{.}$$

T_{CP} is the CP length.

The protocol may predefine an uplink signal of the CP length as the mode or state switching request signal. The terminal device may send the foregoing mode or state switching request signal of the CP length, to request mode or state switching.

In the foregoing design, the terminal device and/or the access network device may determine the predefined CP length, and communication requirements of different service types may be considered, so as to reduce indication overheads and improve communication performance while meeting a multipath delay requirement.

In a possible implementation, the CP length of the mode switching request signal may be determined based on the service type of the terminal device.

There may be terminal devices of a plurality of service types in a communication system. This is not specifically limited herein. The following describes several common service types, such as an eMBB service, a URLLC service, an IoT service, a customer premise equipment (CPE) service, a V2X service, and an augmented reality (AR)/virtual reality (VR) service.

Different types of terminal devices are located in different scenarios, environments, distance ranges between the terminal devices and the access network device, and the like. Therefore, mode switching request signals with different CP lengths may be designed.

The mode switching request signal in this embodiment of this application may be referred to as an uplink signal, or may be referred to as a signal sent by a terminal, or the like.

Optionally, the terminal device may determine the CP length of the uplink signal based on the service type of the terminal device.

For example, a CP length corresponding to the terminal type 1 is T1, a CP length corresponding to the terminal type 2 is T2, and a CP length corresponding to a terminal type 3 is T3. The terminal type 1, the terminal type 2, and the terminal type 3 may correspond to one or more of terminal types of the eMBB service, the URLLC service, the IoT service, the CPE service, the V2X service, the AR/VR service, or the like.

Optionally, there may be a correspondence or a mapping between the terminal type and the CP length. The correspondence or mapping is predefined in a protocol, or may be configured by the access network device or the core network device for the terminal device by using signaling. This is not specifically limited herein.

Table 3 is an example of a correspondence between a terminal type and a CP length, where at least one row or at least one column in the table may be used as a correspondence. Table 3 uses a row as an example.

TABLE 3

| | |
|---|---|
| Terminal type | CP length |
| Terminal type 1 | T1 |
| Terminal type 2 | T2 |
| ··· | ··· |
| Terminal type y | Ty |

y is a positive integer. The terminal type 1 to the terminal type y may be at least one of the following: a terminal of an eMBB service type, a terminal of a URLLC service type, a terminal of an IoT service type, a terminal of a CPE service type, a terminal of a V2X service type, a terminal of an AR/VR service type, and the like.

T1 to Ty are CP lengths, and a unit may be Ts, µs, or another time unit.

Values of T1 to Ty may be at least one of the following:

20 µs to 100 µs, for example, 23.33 µs, 30 µs, 43.35 µs, 50 µs, 63.36 µs, 70 µs, or 83.37 µs; or 512 Ts to 3168 Ts, for example, 717 Ts, 921 Ts, 1332 Ts, 1536 Ts, 1946 Ts, 2150 Ts, or 2561 Ts.

In the foregoing design, the terminal device and/or the access network device may determine the frame structure, for example, the CP length, based on the service type, and communication requirements of different service types may be considered, so as to reduce indication overheads, reduce CP overheads, and improve communication performance while meeting a multipath delay requirement.

In a possible implementation, the CP length of the mode switching request signal may be configured by the access network device for the terminal device.

The terminal device may receive the CP length that is of the mode or state switching request signal and that is configured by the access network device or the core network.

A value of the CP length may range from 20 µs to 100 µs, for example, 23.33 µs, 30 µs, 43.35 µs, 50 µs, 63.36 µs, 70 µs, or 83.37 µs; or from 512 Ts to 3168 Ts, for example, 717 Ts, 921 Ts, 1332 Ts, 1536 Ts, 1946 Ts, 2150 Ts, or 2561 Ts.

Specifically, the configuration may be performed in one or more of the following manners.

Manner 1.4.1: Direct sending.

Specifically, for example, the value of the CP length is sent by using higher layer signaling.

Manner 1.4.2: The value of the CP length is indicated by using a configured index.

Specifically, for example, numbering is performed based on the value of the CP length, and the value of the CP length is determined through an index of a sent number.

Manner 1.4.3: Implicit notification.

Specifically, for example, related information of the value of the CP length may be sent. For example, the related information may be a terminal type, a scenario, a cell radius, a distance between the terminal device and the access network device, or the like. There is a correspondence between the related information and the value of the CP length. The terminal device may determine the value of the CP length based on the related information and the correspondence.

Optionally, a specific manner may be predefined in a protocol, or may be notified by the access network device to the terminal device by using higher layer signaling or physical layer signaling. This is not specifically limited in this application.

The terminal device may send the mode switching request signal based on the indicated CP length. This manner may be an acknowledgment manner used when the terminal device is not synchronized in uplink, or when the terminal device does not determine a TA value.

The terminal device may roughly estimate a TA value of the terminal device based on positioning or a time path through empirical learning or machine learning, and send an uplink sequence or an uplink signal based on the TA value. The terminal device may avoid sending the uplink sequence or the uplink signal on a PRACH for a long time.

In this case, because there is no uplink synchronization, the uplink sequence or the uplink signal sent by the terminal device may have a long CP length. A specific value of the CP length may be flexibly configured by the access network device. The access network device may determine the TA value by receiving the uplink sequence or the uplink signal, and notify a user of the TA value.

A long CP length can better resist a multipath delay, but a long CP length also causes high overheads, thereby affecting communication performance. Therefore, a plurality of CP lengths may be designed in a system. According to a requirement, the access network device may flexibly configure/determine the CP length, so as to reduce CP overheads and improve communication performance while meeting a multipath delay requirement.

Manner 1.5: The mode switching request signal may be carried on a data channel.

For example, the data channel sent by the terminal device may indicate that current data transmission is the last data transmission. To be specific, information about the last data transmission is the mode switching request signal, and may indicate that the terminal device requests to perform mode switching.

In a possible implementation, after successfully receiving the data, the access network device considers by default that the terminal device switches from the second mode to the first mode.

In a possible implementation, after successfully receiving the data, the access network device may send switching acknowledgment information, and the terminal device receives the switching acknowledgment information, that is, switches from the second mode to the first mode.

Optionally, a manner of the mode switching request signal that is used by the terminal device may be predefined in a protocol, or may be notified by the access network device to the terminal device by using higher layer signaling or physical layer signaling. This is not specifically limited in this application.

Optionally, there is a correspondence between the manner of the mode switching request signal and the service type of the terminal device. This embodiment of this application may be an independent embodiment, or may be combined with another embodiment of this application. This is not specifically limited in this application.

Optionally, the mode switching request signal may correspond to the service type of the terminal device, or may include information about the service type of the terminal device.

Optionally, the terminal device may include the service type identifier of the terminal device in the packet that sends the mode switching request signal, and the access network device determines, based on the service type of the terminal device, the service type of the terminal device that sends the mode switching request signal.

For example, the mode switching request signal includes the service type identifier of the terminal device.

For example, the terminal device may send the mode switching request signal and the service type identifier of the terminal device.

Optionally, when the terminal device sends the mode switching request signal or the state switching request signal, the terminal device sends the service type identifier of the terminal device. In this case, the access network device may determine, based on the service type identifier of the terminal device, the service type identifier of the terminal device that sends the mode switching request signal.

Optionally, the terminal device and/or the access network device may determine a manner of the mode switching request signal based on the service type of the terminal device.

The correspondence or mapping is predefined in a protocol, or may be configured by the access network device or the core network device for the terminal device by using signaling. This is not specifically limited herein.

Table 4 is an example of a correspondence between the terminal type and the manner of the mode switching request signal. At least one row or at least one column in the table may be used as a correspondence. Table 4 uses a row as an example.

TABLE 4

| | |
|---|---|
| Terminal type | Manner of the mode switching request signal |
| Terminal type 1 | Manner as1 |
| Terminal type 2 | Manner as2 |
| ··· | ··· |
| Terminal type m | Manner asm |

m is a positive integer. The terminal type 1 to the terminal type m may be at least one of the following: a terminal of an eMBB service type, a terminal of a URLLC service type, a terminal of an IoT service type, a terminal of a CPE service type, a terminal of a V2X service type, a terminal of an AR/VR service type, and the like.

The manner as 1 to the manner asm may be one or more of the manners of the mode switching request signal described in this application, or may be not limited to the manners of the mode switching request signal described in this application.

The following is an example of the correspondence.

When the service type of the first communication apparatus is an enhanced mobile broadband eMBB type, the manner 1.2 or the manner 1.3 may be used for the mode switching request signal; and/or
when the service type of the first communication apparatus is an internet of things IoT type, the manner 1.2 or the manner 1.4 may be used for the mode switching request signal; and/or
when the service type of the first communication apparatus is an ultra-reliable low-latency communication URLLC type, the manner 1.3 or the manner 1.4 may be used for the mode switching request signal; and/or
when the service type of the first communication apparatus is the CPE type, the manner 1.1 or the manner 1.5 may be used for the mode switching request signal.

Optionally, there is a correspondence between the manner of the mode switching request signal and the service type and the mode of the terminal device.

For example, the terminal device and/or the access network device may determine the manner of the mode switching request signal based on the service type and the mode of the terminal device.

The correspondence or mapping is predefined in a protocol, or may be configured by the access network device or the core network device for the terminal device by using signaling. This is not specifically limited herein.

Table 5 is an example of a correspondence between the terminal type and the manner of the mode switching request signal. At least one row or at least one column in the table may be used as a correspondence. Table 5 uses a row as an example.

TABLE 5

| | | |
|---|---|---|
| Terminal type | Manner of the mode switching request signal switching from the first mode to the second mode | Manner of the mode switching request signal switching from the second mode to the first mode |
| Terminal type 1 | Manner bs1 | Manner cs1 |
| Terminal type 2 | Manner bs2 | Manner cs2 |
| ··· | ··· | ··· |
| Terminal type m | Manner bsm | Manner csm |

m is a positive integer. The terminal type 1 to the terminal type m may be at least one of the following: a terminal of an eMBB service type, a terminal of a URLLC service type, a terminal of an IoT service type, a terminal of a CPE service type, a terminal of a V2X service type, a terminal of an AR/VR service type, and the like.

The manner bs1 to the manner bsm, and the manner cs1 to the manner csm may be one or more of the manners of the mode switching request signal described in this application, or may be not limited to the manners of the mode switching request signal described in this application.

The following is an example of the correspondence.

When the service type of the first communication apparatus is an enhanced mobile broadband eMBB type, a manner of a mode switching request signal corresponding to the first mode is the manner 1.2 or the manner 1.3, and a manner of a mode switching request signal corresponding to the second mode is the manner 1.1 or the manner 1.5; and/or
when the service type of the first communication apparatus is an internet of things IoT type, a manner of a mode switching request signal corresponding to the first mode is the manner 1.2 or the manner 1.4, and a manner of a mode switching request signal corresponding to the second mode is the manner 1.3 or the manner 1.5; and/or
when the service type of the first communication apparatus is an ultra-reliable low-latency communication URLLC type, a manner of a mode switching request signal corresponding to the first mode is the manner 1.2 or the manner 1.4, and a manner of a mode switching request signal corresponding to the second mode is the manner 1.1 or the manner 1.5; and/or
when the service type of the first communication apparatus is the CPE type, a manner of a mode switching request signal corresponding to the first mode is the manner 1.1 or the manner 1.5, and a manner of a mode switching request signal corresponding to the second mode is the manner 1.4 or the manner 1.5.

According to the foregoing design, the terminal device and/or the access network device may determine the mode switching request signal based on the service type, and communication requirements of different service types may be considered, so as to reduce indication overheads, reduce CP overheads, and improve communication performance while meeting a multipath delay requirement.

This embodiment of this application may be an independent embodiment, or may be combined with another embodiment of this application. This is not specifically limited in this application.

Optionally, to determine a relationship between the terminal device and the mode switching request signal, the access network device may use at least one of the following manners.

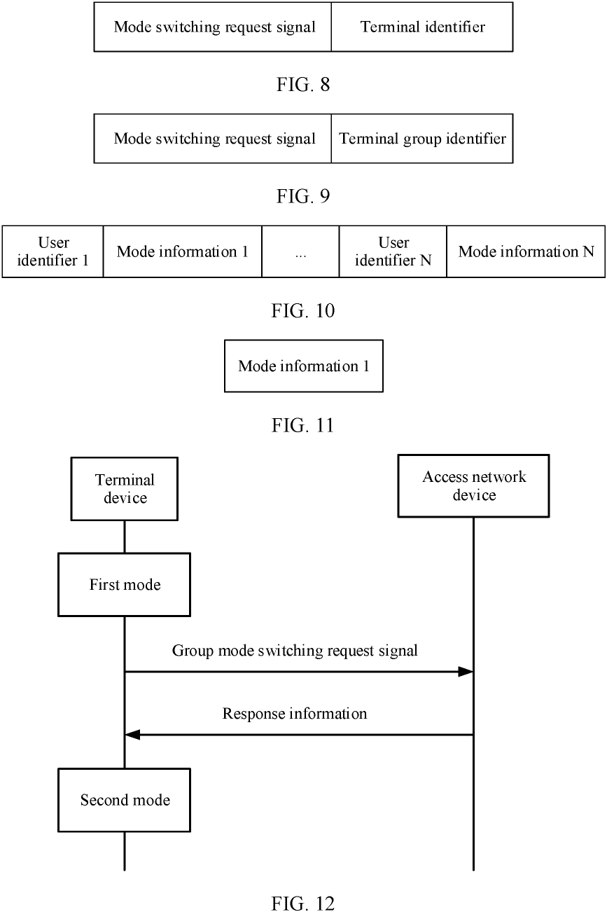

Manner 2.1: The terminal device may include an identifier of the terminal device in a packet in which a mode switching request signal is sent. FIG. 8 is a schematic diagram of a packet. The access network device determines, based on the terminal identifier, the terminal device that sends the mode switching request signal.

For example, the mode switching request signal includes the terminal identifier.

For example, the terminal device may send the mode switching request signal and the terminal identifier.

When the terminal device sends the mode switching request signal or the state switching request signal, the terminal device sends the terminal identifier. In this case, the access network device may determine, based on the terminal identifier, the terminal device that sends the mode switching request signal.

Manner 2.2: The mode switching request signal corresponds to the terminal identifier.

For example, a configuration of the mode switching request signal is a terminal device-level configuration.

It may be understood that, in some cases, the mode switching request signal may indicate a corresponding terminal device. For example, the mode switching request signal is configured by a terminal level.

Optionally, the configuration of the mode switching request signal may include at least one of a time domain resource, a frequency domain resource, a sequence, and a code resource.

For example, at least one of the time domain resource, the frequency domain resource, the sequence, and the code resource corresponds to the terminal identifier. To be specific, the access network device may determine, based on at least one of the time domain resource, the frequency domain resource, the sequence, and the code resource of the received mode switching request signal, the terminal identifier corresponding to the signal, to determine the terminal device.

The terminal identifier in this application is used to identify the terminal, for example, a radio network temporary identifier (RNTI) or a subscriber identity module (SIM) card identifier. A value range of the terminal identifier may be 0 to 65535. The terminal identifier may be a terminal identifier at an access network layer, or may be a terminal identifier at a core network layer. This is not specifically limited herein.

Optionally, the terminal device and/or the access network device may determine an implementation of the mode switching request signal and/or the response information based on the service type of the terminal device. There is a corresponding correspondence or mapping between the service type and the switching request signal and/or the response information.

For example, for a terminal device corresponding to a service type whose first mode is the idle state, a mode switching request signal that may be used is a preamble sequence or a dedicated signal. The response information is DCI acknowledgment or higher layer acknowledgment. Then, the first mode is switched to the second mode.

For a terminal device corresponding to a service type whose first mode is the connected state or the inactive state, a mode switching request signal that may be used is an SRS, an SR, or a dedicated signal. ACK/NACK acknowledgment. Then, the first mode is switched to the second mode.

For terminal devices of a same service type, implementations of mode switching requests and/or response information for switching from the first mode to the second mode and switching from the second mode to the first mode may also be different.

In the foregoing manner, the access network device may determine the terminal device that sends the mode switching request signal, so that mode definitions of the access network device and the terminal device can be consistent.

According to the foregoing embodiment, the terminal device may implement one-click switching or quick switching, to switch from the first mode to the second mode (for example, directly enter a data transmission mode from the idle state or the inactive state), or switch from the second mode to the first mode, so as to reduce signaling overheads, reduce a switching delay, and meet data transmission requirements in different modes.

In some application scenarios, for example, a mechanical arm scenario, a plurality of (two or more) terminal devices synchronously receive data and complete one task at the same time. The plurality of terminal devices in such a scenario form a group of terminal devices. The following describes a case in which the group of terminal devices perform mode switching in batches.

The group of terminal devices may be referred to as a terminal device group, or group terminal devices, or group terminals, a terminal group, or the like. This is not specifically limited in this application.

For example, the first terminal is a head terminal device/anchor terminal device. The head terminal device/anchor terminal device is a terminal that can send a group mode switching request signal to the access network device. The group mode switching request signal indicates that modes of a plurality of terminal devices in the group terminal devices are switched. Generally, modes of all terminal devices in the group terminal devices are switched. That is, the group mode switching request signal may indicate, to the access network device, that a group of users request mode switching.

To be specific, the group mode switching request signal is used to request the group of communication apparatuses to perform mode switching, and the first terminal is a device in the group of terminal devices.

Optionally, the group mode switching request signal may be carried on a data channel.

For example, the data channel sent by the terminal device may indicate that current data transmission is the last data transmission. To be specific, the information about the last data transmission is the group mode switching request signal, and may indicate that the terminal device requests to perform mode switching. After successfully receiving the data, the access network device considers by default that the terminal device switches from the second mode to the first mode.

Alternatively, after successfully receiving the data, the access network device may send switching acknowledgment information, and the terminal device receives the switching acknowledgment information, that is, switches from the second mode to the first mode.

Optionally, in this embodiment of this application, a manner of the mode switching request signal may be used for the group mode switching request signal. In other words, descriptions about the mode switching request signal in this application is applicable to the group mode switching request signal. This is not specifically limited in this embodiment of this application.

In the foregoing manner, the terminal device can implement one-click switching or quick switching, to switch from the first mode to the second mode (for example, directly enter a data transmission mode from the idle state or the inactive state), so as to avoid random access and reduce RRC signaling overheads. For the group switching request signal, only the first terminal sends a request in the group of terminal devices. Compared with that in which each terminal sends the request signal, signal overheads can be reduced, energy saving of the terminal device can be implemented, and communication efficiency can be improved.

This embodiment of this application may be an independent embodiment, or may be combined with another embodiment of this application. This is not specifically limited in this application.

Optionally, the access network device may send, to the terminal device, configuration information corresponding to the group mode switching request signal. The configuration information includes at least one of a time domain resource, a frequency domain resource, a sequence, and a code resource for sending the group mode or state switching request signal.

Optionally, the configuration information (for example, an uplink transmission resource) of the group mode switching request signal may be configured by the access network device by using higher layer signaling, or may be predefined, or may be notified by the access network device by using physical layer signaling, for example, indicated in DCI. This is not specifically limited herein.

Optionally, the access network device allocates a terminal group identifier to the group of terminal devices. To be specific, the access network device may send configuration information of the terminal group identifier to the terminal device. The terminal group identifier may also be referred to as a group terminal identifier, a terminal device group identifier, a group identifier, or the like. This is not specifically limited in this application.

Optionally, to determine a relationship between the group terminal devices and the mode switching request signal, the access network device may use at least one of the following manners.

Manner 3.1: The first terminal may add the group terminal device identifier to a packet in which the group mode switching request signal is sent. FIG. 9 is a schematic diagram of a packet of the group terminal devices. The access network device determines, based on the group terminal identifier, the terminal device that sends the mode switching request signal.

It may be understood that FIG. 9 is merely a possible implementation, and the first terminal may also add identifiers of all terminal devices in the group terminal devices to a packet in which the mode switching request signal is sent. This is not specifically limited herein.

For example, the first terminal may send a group mode switching request signal and a group terminal identifier.

When the first terminal sends the group mode switching request signal or the group state switching request signal, the first terminal sends the group terminal identifier. In this case, the access network device may determine, based on the group terminal identifier, the terminal group that sends the mode switching request signal.

Manner 3.2: The group mode switching request signal corresponds to the group terminal devices.

For example, a configuration of the group mode switching request signal is a terminal device group-level configuration.

It may be understood that, in some cases, the group mode switching request signal may indicate the corresponding group terminal devices. For example, the mode switching request signal is configured at a terminal group level. Optionally, at least one of a time domain resource, a frequency domain resource, a sequence, and a code resource corresponds to the group terminal identifier. To be specific, the access network device may determine, based on at least one of the time domain resource, the frequency domain resource, the sequence, and the code resource of the mode switching request signal, the group terminal device identifier corresponding to the signal, that is, determining the group terminal devices.

The group terminal identifier in this application is used to identify the group of terminal devices, for example, a group RNTI or a group SIM card identifier. A value range of the group terminal identifier may be 0 to 65535. The group terminal identifier may include an identifier of each terminal device in the group, or may be a dedicated group terminal identifier used to indicate the group of terminal devices. The group terminal identifier may be a group terminal identifier at an access network layer, or may be a group terminal identifier at the core network layer. This is not specifically limited herein.

602: The access network device sends a response information to the terminal device. Correspondingly, the terminal device receives the response information.

Optionally, step 602 may also be omitted. For example, the terminal device may perform mode switching after sending the mode switching request signal. The access network device may not send the response information, or the terminal device may not receive the response information.

Optionally, when the response information is not sent, the access network device may determine, based on a communication state of the terminal device, whether it is possible that the terminal device sends the mode switching request signal but the access network device fails to receive the mode switching request signal. For example, when the access network device receives incorrect data transmission of the terminal device, or the access network device finds that data of the terminal device always fails to be transmitted, the access network device may determine that the mode switching request signal of the terminal device fails to be received. In this case, the access network device may send the mode indication information to the terminal device, or may require the terminal device to send the mode switching request signal again, so as to implement mode understanding consistency between the access network device and the terminal device.

Optionally, the response information may include a terminal identifier or a terminal group identifier.

After receiving the mode switching request signal sent by the terminal device, the access network device may send the response information. The response information is used to indicate that the access network device acknowledges receiving of the mode switching request signal, that is, may also be referred to as acknowledgment response information, may also be referred to as acknowledgment information, or may be referred to as switching acknowledgment response information, or the like. Details are not described herein again. In this embodiment of this application, the response information is used as an example for description.

After receiving a signal carrying the mode switching request signal, the access network device may send acknowledgment response information.

Specifically, the acknowledgment operation may be performed in at least one of the following manners.

Manner 4.1: The response information is DCI.

For example, the access network device may send DCI to schedule uplink data, that is, acknowledge mode switching of the terminal device.

For example, the access network device may send DCI to schedule downlink data, that is, acknowledge mode switching of the terminal device.

Optionally, the access network device may send DCI to schedule uplink data, that is, acknowledge mode switching of the terminal device.

Optionally, the access network device may indicate mode information in the DCI, that is, determine the mode of the terminal.

For example, one bit in the DCI indicates mode information, and the mode information may also be referred to as mode switching information. For example, 0 indicates the first mode (a mode 1), and 1 indicates the second mode (a mode 2); or 1 indicates the first mode, and 0 indicates the second mode.

For state switching, for example, one bit in the DCI indicates state information, and the state information may also be referred to as state switching information. For example, 0 indicates a first state (a state 1), and 1 indicates a second state (a state 2); or 1 indicates a first state, and 0 indicates a second state.

All modes and states in this embodiment of this application may be replaced. Details are not described herein again.

1 bit in this embodiment of this application may also be M bits, where M is a positive integer greater than or equal to 1, for example, may also be 2 bits. This is not specifically limited in this embodiment of this application.

A quantity of bits may depend on a number of modes. For example, the quantity of bits is equal to log2 (the quantity of modes) rounded up.

After receiving the response information, the terminal device may perform mode switching or state switching.

Manner 4.2: The response information is an acknowledgment ACK character or a negative acknowledgment NACK character.

For example, the terminal device may transmit data on a preconfigured resource. The preconfigured resource is an uplink transmission resource. Optionally, the access network device may configure the uplink transmission resource for the terminal device, for example, may configure the uplink transmission resource by using higher layer signaling (for example, RRC signaling or MAC signaling).

For example, if the access network device sends the ACK, it indicates that the access network device correctly receives the mode switching request signal. If the access network device sends the NACK, it indicates that the access network device does not correctly receive the mode switching request signal, or it indicates that the access network device does not allow the terminal device to perform mode switching, that is, rejects a request of the terminal device.

For example, a NACK only manner may be used, that is, the NACK is fed back only when receiving fails, and no NACK is fed back when receiving succeeds. Alternatively, the NACK is fed back only when the request of the terminal device is rejected, and no NACK is fed back when the request of the terminal device is allowed.

A time-frequency resource location at which the access network device sends the ACK/NACK may be predefined in a protocol, or may be configured by the access network device for the terminal device.

Alternatively, there may be a correspondence between the time-frequency resource location at which the access network device sends the ACK/NACK and a time-frequency resource location of the mode switching request signal. The terminal device may detect the signal at the time-frequency resource location of the ACK/NACK that corresponds to the time-frequency resource location of the mode switching request signal, to further determine the switching acknowledgment response sent by the access network device.

Optionally, when sending the mode switching request signal, the terminal device may also transmit data.

The terminal device may transmit data on the preconfigured resource. The preconfigured resource is an uplink transmission resource.

For example, the access network device may configure the uplink transmission resource for the terminal device, for example, may configure the uplink transmission resource by using higher layer signaling (for example, RRC signaling or MAC signaling).

Optionally, the response information may be sent together with a data feedback. For example, when the terminal sends a data channel, the access network device may receive data carried on the data channel (for example, data transmitted on a physical uplink shared channel (PUSCH)). If the access network device feeds back the ACK when the PUSCH is successfully received, it indicates that the data is successfully received, and it indicates that the mode switching request signal is successfully received, or the access network device allows the terminal device to perform mode switching. If the access network device feeds back the NACK when the PUSCH fails to be received, it indicates that the data fails to be received, and it indicates that the mode switching request signal fails to be received, or the access network device does not allow the terminal device to perform mode switching.

Optionally, the response information and the data feedback may be sent separately. For example, when the terminal device sends a data channel, the access network device may receive data carried on the data channel (for example, the data transmitted on the PUSCH). If the access network device feeds back the ACK when the PUSCH is successfully received, it indicates that the data is successfully received. The access network device may send the ACK for the mode switching request signal. It indicates that the mode switching request signal is successfully received, or the access network device allows the terminal device to perform mode switching. If the access network device feeds back the NACK when the PUSCH fails to be received, it indicates that the data fails to be received. The access network device may send the NACK for the mode switching request signal. It indicates that the mode switching request signal fails to be received, or the access network device does not allow the terminal device to perform mode switching. The access network device may send two pieces of ACK/NACK information, where one indicates acknowledgment of the mode switching request signal, and the other indicates acknowledgment of the data. A sequence is not limited, and may be predefined, or may be configured by the access network device.

This manner may be an acknowledgment manner used when the terminal device has been synchronized in uplink, or the terminal device has determined a TA value.

Manner 4.3: The response information is higher layer signaling.

When receiving the mode switching request signal, the access network device may send higher layer signaling, for example, RRC layer signaling or MAC layer signaling. In other words, the access network device notifies the terminal device that the mode switching request signal is successfully received or fails to be received, or grants or rejects the mode switching request signal of the terminal device.

When granting the mode switching request signal of the terminal device, the access network device may send agreement (for example, agree) information or completion (for example, complete) information to the terminal device.

When rejecting the mode switching request signal of the terminal device, the access network device may send rejection (for example, reject) information or release (for example, release) information to the terminal device.

For at least one of the foregoing three manners, the terminal device may determine, after receiving the acknowledgment information, that the access network device correctly receives the mode or state switching request information. In other words, the terminal device may perform mode or state switching based on the acknowledgment information.

Optionally, there is a correspondence between a manner of the foregoing response information and a service type of the terminal device. This embodiment of this application may be an independent embodiment, or may be combined with another embodiment of this application. This is not specifically limited in this application.

Optionally, the terminal device and/or the access network device may determine the manner of the response information based on the service type of the terminal device.

The correspondence or mapping is predefined in a protocol, or may be configured by the access network device or the core network device for the terminal device by using signaling. This is not specifically limited herein.

Table 6 is an example of a correspondence between the terminal type and the manner of response information, where at least one row or at least one column in the table may be used as a correspondence. Table 6 uses a row as an example.

TABLE 6

| | |
|---|---|
| Terminal type | Manner of response information |
| Terminal type 1 | Manner ay1 |
| Terminal type 2 | Manner ay2 |
| ··· | ··· |
| Terminal type m | Manner aym |

m is a positive integer. The terminal type 1 to the terminal type m may be at least one of the following: a terminal of an eMBB service type, a terminal of a URLLC service type, a terminal of an IoT service type, a terminal of a CPE service type, a terminal of a V2X service type, a terminal of an AR/VR service type, and the like.

The manner ay 1 to the manner aym may be one or more of the manners of the response information described in this application, or may be not limited to the manners of the response information described in this application.

The following is an example of the correspondence.

When the service type of the first communication apparatus is an enhanced mobile broadband eMBB type, the manner 4.1 or the manner 4.3 may be used for the response information; and/or
when the service type of the first communication apparatus is an internet of things IoT type, the manner 4.2 or the manner 4.3 may be used for the response information; and/or
when the service type of the first communication apparatus is an ultra-reliable low-latency communication URLLC type, the manner 4.1 or the manner 4.2 may be used for the response information; and/or
when the service type of the first communication apparatus is a CPE type, the manner 4.1 may be used for the response information.

Optionally, there is a correspondence between the manner of the response information and the service type and the mode of the terminal device.

For example, the terminal device and/or the access network device may determine the manner of the response information based on the service type and the mode of the terminal device.

The correspondence or mapping is predefined in a protocol, or may be configured by the access network device or the core network device for the terminal device by using signaling. This is not specifically limited herein.

Table 7 is an example of a correspondence between the terminal type and the manner of response information, where at least one row or at least one column in the table may be used as a correspondence. Table 7 uses a row as an example.

TABLE 7

| | | |
|---|---|---|
| Terminal type | Manner of response information of switching from the first mode to the second mode | Manner of response information of switching from the second mode to the first mode |
| Terminal type 1 | Manner by1 | Manner cy1 |
| Terminal type 2 | Manner by2 | Manner cy2 |
| ··· | ··· | ··· |
| Terminal type m | Manner bym | Manner cym |

m is a positive integer. The terminal type 1 to the terminal type m may be at least one of the following: a terminal of an eMBB service type, a terminal of a URLLC service type, a terminal of an IoT service type, a terminal of a CPE service type, a terminal of a V2X service type, a terminal of an AR/VR service type, and the like.

The manner by1 to the manner bym, and the manner cy1 to the manner cym may be one or more of manners of the response information described in this application, or may be not limited to a mode or a state described in this application.

The following is an example of the correspondence.

When the service type of the first communication apparatus is an enhanced mobile broadband eMBB type, a manner of response information corresponding to the first mode is the manner 4.2, and a manner of response information corresponding to the second mode is the manner 4.1; and/or
when the service type of the first communication apparatus is an internet of things IoT type, a manner of response information corresponding to the first mode is the manner 4.3, and a manner of response information corresponding to the second mode is the manner 4.1; and/or
when the service type of the first communication apparatus is an ultra-reliable low-latency communication URLLC type, a manner of response information corresponding to the first mode is the manner 4.2 or the manner 4.3, and a manner of response information corresponding to the second mode is the manner 4.1 or the manner 4.2; and/or
when the service type of the first communication apparatus is a CPE type, a manner of response information corresponding to the first mode is the manner 4.1 or the manner 4.2, and a manner of response information corresponding to the second mode is the manner 4.1 or the manner 4.3.

In the foregoing design, the terminal device and/or the access network device may determine/determine the response information based on the service type, and communication requirements of different service types may be considered, so as to reduce indication overheads, reduce CP overheads, and improve communication performance while meeting a multipath delay requirement.

Optionally, a transmission resource used by the access network device to send the acknowledgment information may be notified by the access network device to the terminal, for example, at least one of a time domain resource, a frequency domain resource, and a code resource (sequence) that include the transmission resource. Optionally, the code resource or the sequence may be bound to the terminal identifier.

In this application, the access network device may send acknowledgment information to the terminal device, to enhance reliability of mode switching. The access network device and the terminal device have a same definition of the mode or the state.

When the mode switching request signal sent by the terminal device does not have the terminal identifier, the response information returned by the access network device to the terminal device may include the terminal identifier. Optionally, in the response information, a radio network temporary identifier, for example, a cell radio network temporary identifier (C-RNTI), may also be allocated to the terminal.

When terminals on which mode switching is to be performed are a group of terminal devices, for example, in the mechanical arm scenario described in step 601, the access network device may send the response information to only a first terminal (a head terminal device/an anchor terminal device), or may send the response information to each terminal device in the group of terminal devices. This is not specifically limited herein. It may be understood that, when the terminals on which mode switching is to be performed are the group of terminal devices, the response information in this case may be the same as or different from the foregoing scenario controlled by each terminal device. For example, the response information of the terminal device group may include a group identifier.

For example, when the response information is DCI, the access network device may send one piece of DCI to each terminal device in the group of terminal devices as the acknowledgment information.

For example, when the response information is DCI, the access network device may send one piece of DCI, for example, group DCI, to a group of terminal devices as the acknowledgment information. The group of DCI may be received by the first terminal, that is, the group of DCI may be unicast. Alternatively, the group of DCI may be received by each terminal device in the group of terminal devices. To be specific, the group of DCI may be broadcast or multicast.

Optionally, after the first terminal receives the response information from the access network device, the first terminal sends a mode switching indication to the second terminal, where the second terminal is a device in the foregoing group of terminal devices.

In the foregoing manner, the first terminal may indicate the second terminal in the terminal group to which the first terminal belongs to perform mode switching. The second terminal may perform mode switching after receiving the mode switching indication of the first terminal. That is, modes in the terminal group may be consistent, so as to cooperatively complete data communication, thereby improving group communication efficiency.

Optionally, the access network device may allocate a group identifier to the group of terminal devices, and DCI scrambled by using the group identifier carries mode switching information.

Optionally, the group DCI may carry identifiers of a plurality of terminal devices and mode information corresponding to the plurality of terminal devices. Refer to FIG. 10.

Optionally, the group DCI may include only one piece of mode information, that is, modes of the terminal devices corresponding to the group identifier are all a same mode. Refer to FIG. 11.

Optionally, in this embodiment of this application, mode switching DCI and data scheduling DCI may share one piece of DCI. For example, the DCI may indicate mode information, or may perform data scheduling. For example, the DCI includes an information field used to indicate data scheduling, such as a time-frequency domain resource allocation field for data receiving or sending and a modulation and coding scheme field (MCS field).

For example, DCI that carries mode or state information may also be referred to as mode switching DCI, and may be referred to as switching DCI for short.

Optionally, a data channel (for example, a PDSCH or a PUSCH, or a physical downlink shared channel/physical uplink shared channel) scheduled by using the DCI may carry data, or may carry higher layer signaling, for example, RRC signaling or MAC signaling, that is, may carry higher layer configuration information.

Optionally, in this application, the mode or state switching DCI may be dedicated DCI.

Optionally, the mode or state switching information in this application may also be referred to as mode or state information for short.

Further, after receiving the mode or state switching information, the terminal device may determine whether to perform mode or state switching.

603: The terminal device switches the mode.

In a possible implementation, after sending the mode switching request, the terminal device can perform mode switching without receiving an acknowledgment from the access network device. The mode switching request signal is used to notify the access network device that the terminal device is to perform mode switching. For example, this manner is applicable to a scenario in which the second mode is switched to the first mode.

In a possible implementation, after receiving the response information sent by the access network device, the terminal device switches the mode based on the response information. For example, this manner is applicable to a scenario in which the first mode is switched to the second mode.

When the response information is switching acknowledgment, the terminal device may perform mode switching. For example, when the terminal device is in the first mode, and the mode request signal requests to switch to the second mode, the terminal device may switch from the first mode to the second mode.

When the response information is switching rejection, the terminal device cannot perform mode switching. For example, when the terminal device is in the first mode, and the mode request signal requests to switch to the second mode, the terminal device needs to continue to maintain the first mode.

According to the foregoing embodiment, the terminal device may implement one-click switching or quick switching, to switch from the first mode to the second mode (for example, directly enter a data transmission mode from the idle state or the inactive state), or switch from the second mode to the first mode, so as to reduce signaling overheads, reduce a switching delay, and meet data transmission requirements in different modes.

This embodiment of this application may be an independent embodiment, or may be combined with another embodiment of this application. This is not specifically limited in this application.

FIG. 12 is a schematic diagram of a mode switching procedure. In FIG. 12, that a terminal device switches from a first mode (a mode 1) to a second mode (a mode 2) is merely used as an example for description. It may be understood that mode switching of the terminal device may also be switched from the second mode (the mode 2) to the first mode (the mode 1). A schematic flowchart of a mode switching method according to an embodiment of this application includes the following steps.

1201: A terminal device sends a mode switching request signal to an access network device. Correspondingly, the access network device receives a mode switching request signal sent by the terminal device.

For a specific operation, refer to 601. Details are not described herein again.

1202: The access network device sends a switching acknowledgment response to the terminal device. Correspondingly, the terminal device receives the switching acknowledgment response sent by the access network device.

For a specific operation, refer to 602. Details are not specifically described herein again, and this step may also be omitted.

1203: The terminal device switches the mode.

For a specific operation, refer to 603. Details are not described herein again.

A schematic flowchart of a mode switching method in the embodiment of this application is described from a perspective of a first communication apparatus. The schematic flowchart includes the following steps.

1201′: The first communication apparatus sends a mode switching request signal. For a specific operation, refer to 601. Details are not described herein again.

1202′: The first communication apparatus receives a switching acknowledgment response. For a specific operation, refer to 602. Details are not described herein again, and this step may also be omitted.

1203′: The first communication apparatus switches a mode. For a specific operation, refer to 603. Details are not described herein again.

A schematic flowchart of a mode switching method in the embodiment of this application is described from a perspective of a second communication apparatus. The schematic flowchart includes the following steps.

1201*: The second communication apparatus receives a mode switching request signal. For a specific operation, refer to 601. Details are not described herein again.

1202*: The second communication apparatus sends a switching acknowledgment response. For a specific operation, refer to 602. Details are not specifically described herein again, and this step may also be omitted.

The terminal device may send a mode switching request signal, and the access network device may perform response information after receiving the signal. When the terminal device receives an acknowledgment response, the terminal device may quickly perform mode switching. Optionally, when sending the mode switching request signal, the terminal may also send data, so that the terminal device quickly receives and sends data. Further, the access network device may send response information, that is, notify the access network device that the switching information is correctly received, and may make a grant or reject response, so as to implement consistent understanding of states of the access network device and the terminal, and improve communication robustness.

According to the foregoing embodiment, the terminal device may implement one-click switching or quick switching, to switch from the first mode to the second mode (for example, directly enter a data transmission mode from the idle state or the inactive state), or switch from the second mode to the first mode, so as to reduce signaling overheads, reduce a switching delay, and meet data transmission requirements in different modes.

This embodiment of this application may be an independent embodiment, or may be combined with another embodiment of this application. This is not specifically limited in this application.

It may be understood that in some application scenarios, for example, a mechanical arm scenario, when a group of terminal devices synchronously perform mode switching:
if the access network device sends response information to each terminal device in the group of terminal devices, each terminal device performs mode switching based on the response information received by the terminal device; or
if the access network device sends the response information to only a first terminal (a head terminal device/an anchor terminal device), another terminal device, for example, a second terminal, in the group of terminal devices, may perform mode switching by accepting a mode switching indication from the first terminal.

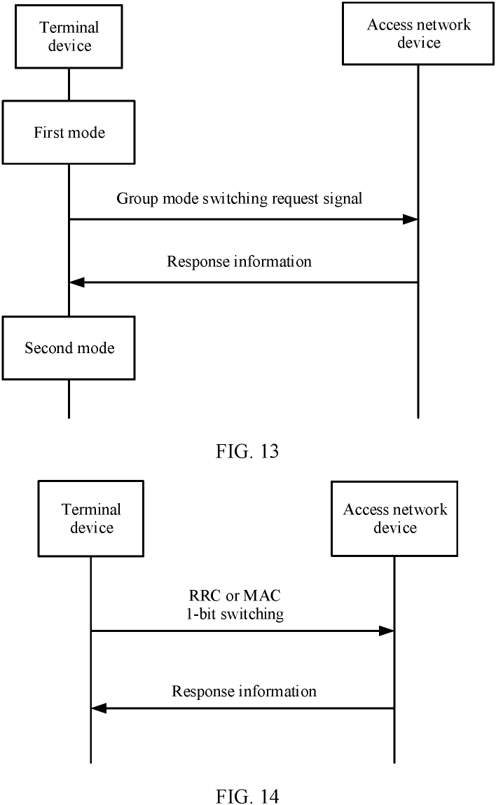

FIG. 13 is a schematic diagram of a mode switching procedure. In FIG. 13, that a terminal device switches from a first mode (a mode 1) to a second mode (a mode 2) is merely used as an example for description. A schematic flowchart of a mode switching method according to an embodiment of this application includes the following steps.

1301: A terminal device sends a group mode switching request signal to an access network device. Correspondingly, the access network device receives the group mode switching request signal sent by the terminal device.

For a specific operation, refer to 601. Details are not described herein again.

1302: The access network device sends a switching acknowledgment response to the terminal device. Correspondingly, the terminal device receives the switching acknowledgment response from the access network device.

For a specific operation, refer to 602. Details are not specifically described herein again, and this step may also be omitted.

1303: The terminal device switches the mode.

For a specific operation, refer to 603. Details are not described herein again.

A schematic flowchart of a mode switching method in the embodiment of this application is described from a perspective of a first communication apparatus. The schematic flowchart includes the following steps.

1301′: The first communication apparatus sends a group mode switching request signal.

For a specific operation, refer to 601. Details are not described herein again.

1302′: The first communication apparatus receives a switching acknowledgment response.

For a specific operation, refer to 602. Details are not specifically described herein again, and this step may also be omitted.

1303′: The first communication apparatus switches a mode. For a specific operation, refer to 603. Details are not described herein again.

A schematic flowchart of a mode switching method in the embodiment of this application is described from a perspective of a second communication apparatus. The schematic flowchart includes the following steps.

1301*: A second communication apparatus receives a group mode switching request signal.

For a specific operation, refer to 601. Details are not described herein again.

1302*: The second communication apparatus sends a switching acknowledgment response.

For a specific operation, refer to 602. Details are not specifically described herein again, and this step may also be omitted.

When mode switching is performed, a group switching request signal is used, and a group of terminal devices send a request by using only one of the terminal devices (for example, a first terminal). Compared with that in which a request signal is sent by using each terminal device, signal overheads can be reduced, and advantages of implementing energy saving and improving efficiency are provided.

This embodiment of this application may be an independent embodiment, or may be combined with another embodiment of this application. This is not specifically limited in this application.

In a possible implementation, when the terminal device is in the second mode (a mode 2), if the terminal device does not receive new downlink data (for example, DCI scheduling data) within preset duration, the terminal device may switch the mode of the terminal device from the second mode (the mode 2) to the first mode (a mode 1), to reduce an energy loss of the terminal device.

According to the foregoing embodiment, the terminal device may implement one-click switching or quick switching, to switch from the first mode to the second mode (for example, directly enter a data transmission mode from the idle state or the inactive state), or switch from the second mode to the first mode, so as to reduce RRC signaling overheads, reduce a switching delay, and meet data transmission requirements in different modes.

This embodiment of this application may be an independent embodiment, or may be combined with another embodiment of this application. This is not specifically limited in this application.

The following embodiment provides a mode switching method.

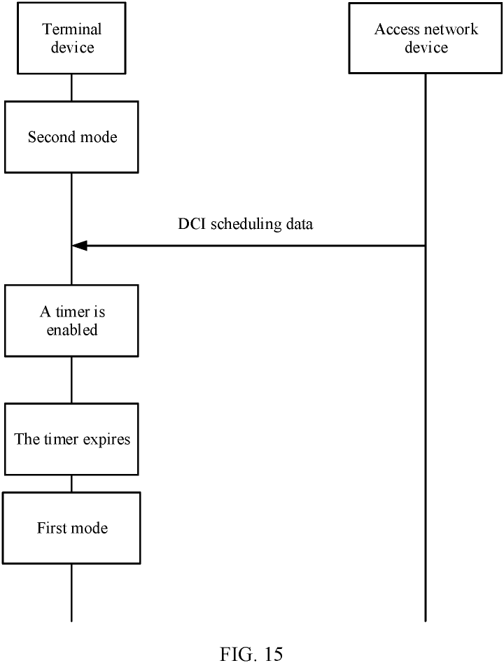

FIG. 14 is a schematic diagram of a mode switching procedure. In the following procedure, a terminal device may send mode or state information. Further, the access network device may send switching acknowledgment information, that is, notify the terminal device that the switching information is correctly received. After receiving the information, the terminal device can quickly perform mode or state switching. In this way, understanding of the state or the mode of the access network device is consistent with that of the terminal device, thereby improving communication robustness. A schematic flowchart of a mode switching method according to an embodiment of this application includes the following steps.

1401: A terminal device sends a mode switching request signal to an access network device. Correspondingly, the access network device receives the mode switching request signal sent by the terminal device.

The mode switching request signal sent by the terminal device may be 1-bit indication mode switching (RRC signaling or MAC signaling). For example, 0 indicates the first mode, and 1 indicates the second mode; or 1 indicates the first mode, and 0 indicates the second mode.

1 bit in this embodiment of this application may also be M bits, where M is a positive integer greater than or equal to 1, for example, may also be 2 bits. This is not specifically limited in this application.

A quantity of bits may depend on a quantity of modes or states. For example, the quantity of bits is equal to log2 (a quantity of modes or a quantity of states) rounded up.

Optionally, a transmission resource used by the terminal device to send the mode switching request signal may be notified by the base station access network device to the terminal, for example, at least one of a time domain resource, a frequency domain resource, and a code resource (sequence) that include the transmission resource. The transmission resource may be a common uplink transmission resource, that is, an uplink transmission resource jointly used by a plurality of terminal devices. Alternatively, the transmission resource may be a dedicated uplink transmission resource of the terminal device, that is, an uplink transmission resource that can be used only by the terminal device.

For a specific operation, refer to 601. Details are not described herein again.

1402: The access network device sends a switching acknowledgment response to the terminal device, where in response, the terminal device receives the switching acknowledgment response from the access network device.

After receiving the information that carries the mode or the state, the access network device may send response information. For a specific operation, refer to 602. Details are not specifically described herein again, and this step may also be omitted.

1403: The terminal device switches the mode.

For a specific operation, refer to 603. Details are not described herein again.

A schematic flowchart of a mode switching method in the embodiment of this application is described from a perspective of a first communication apparatus. The schematic flowchart includes the following steps.

1401′: The first communication apparatus sends a mode switching request signal.

For a specific operation, refer to 1401. Details are not described herein again.

1402′: The first communication apparatus receives a switching acknowledgment response.

For a specific operation, refer to 602. Details are not specifically described herein again, and this step may also be omitted.

1403′: The first communication apparatus switches the mode.

For a specific operation, refer to 603. Details are not described herein again.

A schematic flowchart of a mode switching method in the embodiment of this application is described from a perspective of a second communication apparatus. The schematic flowchart includes the following steps.

1401*: The second communication apparatus receives a mode switching request signal.

For a specific operation, refer to 1401. Details are not described herein again.

1402*: The second communication apparatus sends a switching acknowledgment response.

For a specific operation, refer to 602. Details are not specifically described herein again, and this step may also be omitted.

According to the foregoing embodiment, the terminal device can implement one-click switching or quick switching, to switch from the first mode to the second mode (for example, directly enter a data transmission mode from the idle state or the inactive state), or switch from the second mode to the first mode, so as to reduce RRC signaling overheads, reduce a switching delay, and meet data transmission requirements in different modes.

This embodiment of this application may be an independent embodiment, or may be combined with another embodiment of this application. This is not specifically limited in this application.

The following embodiment provides a mode switching method. When the terminal device is in the second mode, if the terminal device receives no information from the access network device within preset duration (for example, 100 milliseconds or 200 milliseconds), the terminal device may switch to the first mode.

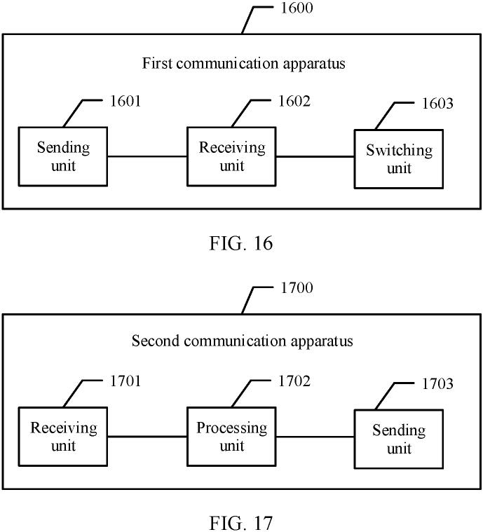

This embodiment is described by using an example in which preset duration is a timing device (a timer). FIG. 15 is a schematic diagram of a mode switching procedure.

For example, when a mode of the first communication apparatus is the second mode, the terminal device switches from the second mode to the first mode based on a timer.

Duration of the timer may be predefined in a protocol, or may be notified by the access network device to the terminal device by using signaling, for example, higher layer signaling such as RRC signaling or MAC signaling.

The terminal device starts the timer when receiving the DCI. When no DCI is received within a period in which a time of the timer is met (for example, when the timer is 100 milliseconds, no DCI is received within 100 milliseconds), the terminal device switches from the second mode to the first mode.

Optionally, there is a correspondence between the timer duration and the service type of the terminal device. The correspondence or mapping is predefined in a protocol, or may be configured by the access network device or the core network device for the terminal by using signaling. This is not specifically limited herein.

Table 8 is an example of a correspondence between a terminal type and timer duration. At least one row or at least one column in the table may be used as a correspondence. Table 8 uses a row as an example.

TABLE 8

| | |
|---|---|
| Terminal type | Timer time length |
| Terminal type 1 | TM1 |
| Terminal type 2 | TM2 |
| ··· | ··· |
| Terminal type ym | TMy |

ym is a positive integer. The terminal type 1 to the terminal type ym may be at least one of the following: a terminal of an eMBB service type, a terminal of a URLLC service type, a terminal of an IoT service type, a terminal of a CPE service type, a terminal of a V2X service type, a terminal of an AR/VR service type, and the like.

TM1 to TMy are timer duration, and a unit may be ms, µs, or another time unit, for example, 5 ms, 10 ms, 15 ms, 100 µs, and 50 µs.

TM1 to TMy are timer duration, and a unit may be a symbol, a slot, a subframe, a radio frame, or another time unit, for example, 5 slots, 10 subframes, 10 radio frames, or 20 symbols. Timers of different duration may be configured for terminal devices of different service types, to meet different service requirements of various services, and implement energy saving of terminal devices of different degrees. The duration of the timer may be determined based on the service type of the terminal device, or may be configured by using terminal-level signaling.

According to the foregoing embodiment, the terminal device can implement quick switching, for example, directly enter an energy-saving mode from a data transmission mode (switch from the second mode to the first mode), so as to reduce signaling overheads, reduce a switching delay, implement energy saving of the terminal device, and improve communication efficiency.

This embodiment of this application may be an independent embodiment, or may be combined with another embodiment of this application. This is not specifically limited in this application.

The method in embodiments of this application is applied between a first communication apparatus and a second communication apparatus, and may be applied between an access network device and a terminal device, or may be applied between a terminal device and a terminal device, or may be applied between a terminal device and a core network device. In this embodiment of this application, only an example in which the first communication apparatus is the terminal device and the second communication apparatus is the access network device is used for description. In other words, a scenario in which the access network device communicates with the terminal device is used as an example for description. Refer to the method shown in FIG. 6. It may be understood that if the first communication apparatus is the terminal device, and the second communication apparatus is the core network device, that is, in a scenario in which the terminal device communicates with the core network device, the access network device in the steps in the embodiment shown in FIG. 6 may be changed to the core network device, that is, the core network device performs the steps performed by the access network device in the embodiment shown in FIG. 6. Details are not described herein again.

The following describes the core network device. The core network device is a device in a core network (CN) that provides service support for a terminal. Currently, some examples of the core network device are an access and mobility management function (AMF) entity, a session management function (SMF) entity, a user plane function (UPF) entity, and the like, which are not listed one by one herein. The AMF entity may be responsible for access management and mobility management of the terminal. The SMF entity may be responsible for session management, for example, session establishment of a user. The UPF entity may be a functional entity on a user plane, and is mainly responsible for a connection to an external network. It should be noted that an entity in this application may also be referred to as a network element or a functional entity. For example, the AMF entity may also be referred to as an AMF network element or an AMF functional entity. For another example, the SMF entity may also be referred to as an SMF network element or an SMF functional entity. This is not specifically limited herein.

Simply put, a mobile network can be divided into three parts: base station subsystem, network subsystem, and system support part, such as security management. The core network is located in the network subsystem. A main function of the core network is to connect call requests or data requests from an air interface to different networks.

Main functions of the core network device include providing a user connection, managing a user, completing service carrying, and acting as a bearer network to provide an interface to an external network. The establishment of user connections includes mobility management (MM), calling management (CM), switching/routing, recording notification (completing a connection relationship to intelligent network peripherals in combination with an intelligent network service), and other functions. The user management includes user description, quality of service (QoS) (description of user service QoS is added), user communication record (Accounting), virtual home environment (VHE). (Dialogue with an intelligent network platform provides a virtual home environment), and security (an authentication center provides security measures, including security management for mobile services and security processing for external network access.) A bearer connection (access to) includes an external public switched telephone network (PSTN), an external circuit data network and a packet data network, an internet and an enterprise intranet, and short message service (SMS) server of China Mobile. Basic services provided by the core network include mobile office, e-commerce, communication, entertainment, travel and location-based services, and telemetry, that is, simple message transfer service (monitoring control).

Optionally, embodiments of this application may be applied to communication between the access network device and the terminal device, or may be applied to communication between a terminal device and a terminal device, or may be applied to communication between a satellite device and an access network device, or may be applied to communication between a satellite device and a terminal device, or communication between devices of another type. This is not specifically limited in this application.

Optionally, the uplink data or the downlink data in this embodiment of this application may alternatively be sidelink data, backhaul data, access data, another type of data, or the like. This is not specifically limited in this application.

The foregoing describes the mode switching method in embodiments of this application, and the following describes an apparatus in embodiments of this application. Refer to FIG. 16. An embodiment of a first communication apparatus 1600 in embodiments of this application includes a sending unit 1601, a receiving unit 1602, and a switching unit 1603.

The sending unit 1601 is configured to send a first signal to a second communication apparatus, and is further configured to send a mode switching indication to a third communication apparatus, where the third communication apparatus is an apparatus in the foregoing group of communication apparatuses.

The receiving unit 1602 is configured to receive first response information from the second communication apparatus, and is further configured to receive second response information from the second communication apparatus.

The switching unit 1603 is configured to switch a mode, and is further configured to: when the mode of the first communication apparatus is a second mode, switch from the second mode to the first mode based on a timer.

Each unit may perform the operations performed by the terminal device in any one of the embodiments shown in FIG. 6 or FIG. 12 to FIG. 15. Details are not described herein again.

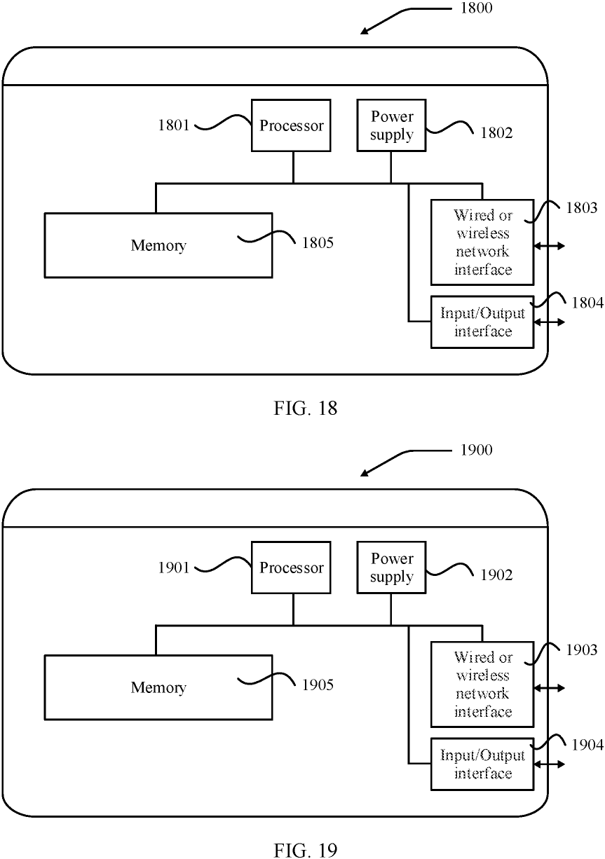

Refer to FIG. 17. An embodiment of a second communication apparatus 1700 in embodiments of this application includes a receiving unit 1701, a processing unit 1702, and a sending unit 1703.

The receiving unit 1701 is configured to receive a first signal.

The processing unit 1702 is configured to determine a mode of a first communication apparatus.

The sending unit 1703 is configured to send first response information, and is further configured to send second response information to the first communication apparatus, or send second response information to each apparatus in the group of communication apparatuses.

Each unit may perform an operation performed by the access network device in any one of embodiments shown in FIG. 6 or FIG. 12 to FIG. 15. Details are not described herein again.

Refer to FIG. 18. An embodiment of this application provides a terminal device 1800. The terminal device may be used as a first communication apparatus. The terminal device 1800 may include one or more processors 1801 and a memory 1805. The memory 1805 stores program code. Further, the memory 1805 may further store data.

The memory 1805 may be a volatile memory, a non-volatile memory, or a persistent memory. The program code stored in the memory 1805 may include one or more modules, and each module may include a series of instruction operations for the terminal device. Further, the processor 1801 may be configured to communicate with the memory 1805, and perform, in the terminal device 1800, the series of instruction operations in the memory 1805.

The terminal device 1800 may further include one or more power supplies 1802, one or more wired or wireless network interfaces 1803, and one or more input/output interfaces 1804.

The processor 1801 may perform the operations performed by the terminal device in any one of embodiments shown in FIG. 6 or FIG. 12 to FIG. 15. Details are not described herein again.

Refer to FIG. 19. An embodiment of this application provides an access network device 1900. The access network device may be used as a second communication apparatus. The access network device 1900 may include one or more processors 1901 and a memory 1905. The memory 1905 stores program code. Further, the memory 1905 may further store data.

The memory 1905 may be a volatile memory, a non-volatile memory, or a persistent memory. The program code stored in the memory 1905 may include one or more modules, and each module may include a series of instruction operations for the access network device. Further, the processor 1901 may be configured to communicate with the memory 1905, and perform, on the access network device 1900, a series of instruction operations in the memory 1905.

The access network device 1900 may further include one or more power supplies 1902, one or more wired or wireless network interfaces 1903, and one or more input/output interfaces 1904.

The processor 1901 may perform the operations performed by the access network device in any one of embodiments shown in FIG. 6 or FIG. 12 to FIG. 15. Details are not described herein again.

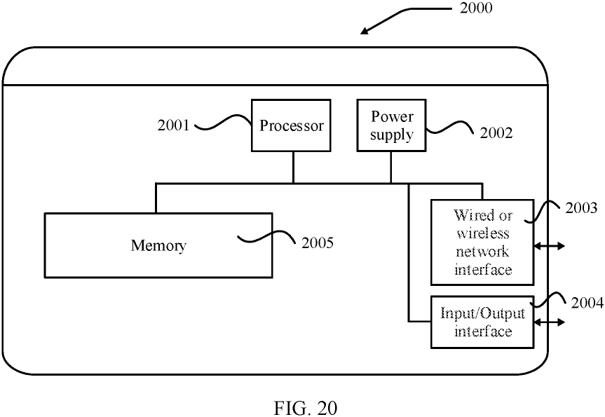

Refer to FIG. 20. An embodiment of this application provides a core network device 2000. The core network device may be used as a second communication apparatus. The core network device 2000 may include one or more processors 2001 and a memory 2005. The memory 2005 stores program code. Further, the memory 2005 may further store data.

The memory 2005 may be a volatile memory, a non-volatile memory, or a persistent memory. The program code stored in the memory 2005 may include one or more modules, and each module may include a series of instruction operations for the core network device. Further, the processor 2001 may be configured to communicate with the memory 2005, and execute, on the core network device 2000, a series of instruction operations in the memory 2005.

The core network device 2000 may further include one or more power supplies 2002, one or more wired or wireless network interfaces 2003, and one or more input/output interfaces 2004.

The processor 2001 may perform the operations performed by the core network device in any one of embodiments shown in FIG. 6 or FIG. 12 to FIG. 15. Details are not described herein again.

An embodiment of this application further provides a communication apparatus. The apparatus includes one or more processors, one or more memories, and one or more transceivers (each transceiver includes a transmitter Tx and a receiver Rx), which are connected by using a bus. The one or more transceivers are connected to one or more antennas. The one or more memories include computer program code. The transceiver may implement a function of the foregoing receiving unit or sending unit, or the transceiver may be a separate receiver and a separate transmitter.

This application provides a network structure. The network structure may be applied to a device such as a terminal device, an access network device, or a core network device. The network structure is coupled to a memory, and is configured to read and execute instructions stored in the memory, so that the network structure implements the steps of the method performed by the access network device, the terminal device, or the core network device in any one of the foregoing implementations.

In a possible design, the network structure is a chip or a system-on-chip.

This application provides a chip system. The chip system includes a processor, configured to support a terminal device, an access network device, or a core network device in implementing functions in the foregoing aspects, for example, sending or processing data and/or information in the foregoing methods. In a possible design, the chip system further includes a memory, and the memory is configured to store necessary program instructions and necessary data. The chip system may include a chip, or may include a chip and another discrete component.

In another possible design, when the chip system is a chip in a terminal device, an access network device, a core network device, or the like, the chip includes a processing unit and a communication unit. The processing unit may be, for example, a processor. The communication unit may be, for example, an input/output interface, a pin, a circuit, or the like.

The processing unit may execute a computer executable instruction stored in a storage unit, so that a chip in the terminal device, the access network device, the core network device, or the like performs the steps of the method performed by the terminal device, the access network device, or the core network device in any one of the foregoing embodiments. Optionally, the storage unit is a storage unit in the chip, for example, a register or a cache. Alternatively, the storage unit may be a storage unit that is in a terminal device, an access network device, or a core network device and that is located outside the chip, for example, a read-only memory (ROM), other types of static storage devices that can store static information and instructions, or random access memory (RAM).

An embodiment of this application further provides a processor, configured to be coupled to a memory, and configured to perform the method and the function that are related to the terminal device in any one of the foregoing embodiments. In a possible implementation, the processor and the memory are integrated together. In another possible implementation, the memory is outside the processor.

An embodiment of this application further provides a processor, configured to be coupled to a memory, and perform the method and the function that are related to the access network device in any one of the foregoing embodiments. In a possible implementation, the processor and the memory are integrated together. In another possible implementation, the memory is outside the processor.

An embodiment of this application further provides a processor, configured to be coupled to a memory, and perform the method and the function that are related to the core network device in any one of the foregoing embodiments. In a possible implementation, the processor and the memory are integrated together. In another possible implementation, the memory is outside the processor.

An embodiment of this application further provides a computer-readable storage medium. The computer-readable storage medium stores a computer program. When the computer program is executed by a computer, the method procedure related to the terminal device, the access network device, or the core network device in any one of the foregoing method embodiments is implemented. Correspondingly, the computer may be the terminal device, the access network device, or the core network device.

It should be understood that the processor mentioned in the terminal device, the access network device, the core network device, the chip system, and the like in the foregoing embodiments of this application, or the processor provided in the foregoing embodiments of this application may be a central processing unit (CPU), or may be another general purpose processor, a digital signal processor (DSP), an application-specific integrated circuit (ASIC), a field programmable gate array (FPGA), or another programmable logic device, a discrete gate or transistor logic device, a discrete hardware component, or the like. The general-purpose processor may be a microprocessor, or the processor may be any conventional processor or the like.

It should be further understood that a quantity of processors in the terminal device, the access network device, the core network device, the chip system, and the like in the foregoing embodiments of this application may be one or a plurality of processors, and may be adjusted based on an actual application scenario. This is merely an example for description and is not limited herein. There may be one or more memories in embodiments of this application. This may be adjusted based on an actual application scenario. This is merely an example for description herein, and is not limited.

It should be further understood that the memory, the readable storage medium, or the like mentioned in the terminal device, the access network device, the core network device, the chip system, and the like in the foregoing embodiments of this application may be a volatile memory or a non-volatile memory, or may include both a volatile memory and a non-volatile memory.

The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), used as an external cache. Through example but not limitative description, many forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchronous link dynamic random access memory (SLDRAM), and a direct rambus dynamic random access memory (DR RAM).

It needs to be further noted that when the terminal device, the access network device, or the core network device includes a processor (or a processing unit) and a memory, the processor in this application may be integrated with the memory, or the processor and the memory may be connected by using an interface. This may be adjusted based on an actual application scenario, and is not limited.

An embodiment of this application further provides a computer program or a computer program product including the computer program. When the computer program is executed on a computer, the computer is enabled to implement the method procedure performed by the terminal device, the access network device, or the core network device in any one of the foregoing method embodiments. Correspondingly, the computer may be the terminal device, access network device, or core network device.

All or some of the foregoing embodiments may be implemented by using software, hardware, firmware, or any combination thereof. When the software is used to implement embodiments, all or some of the embodiments may be implemented in a form of a computer program product.

The computer program product includes one or more computer instructions. When the computer program instructions are loaded and executed on the computer, the procedure or functions according to embodiments of this application are all or partially generated. The computer may be a general-purpose computer, a dedicated computer, a computer network, or other programmable apparatuses.

The computer instructions may be stored in a computer-readable storage medium, or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive Solid State Disk (SSD)), or the like.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, in other words, may be located in one position, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of this application essentially, or a part contributing to the conventional technology, or all or some of the technical solutions may be implemented in a form of a software product. The computer software product is stored in a storage medium and includes several instructions for instructing a computer device (which may be a personal computer, a server, another network device, or the like) to perform all or some of the steps of the methods in embodiments in FIG. 6 in embodiments of this application. The storage medium includes various media that can store program code, such as a USB flash drive, a removable hard disk, a read-only memory (ROM), a random access memory (RAM), a magnetic disk, or an optical disc.

In addition, the terms “include”, “contain” and any other variants mean to cover the non-exclusive inclusion, so that a process, method, system, product, or device that includes a series of units is not necessarily limited to those units, but may include other units not expressly listed or inherent to such a process, method, product, or device.

Names of messages/frames/information, modules, units, or the like provided in embodiments of this application are merely examples, and other names may be used provided that the messages/frames/information, modules, units, or the like have same functions.

Terms used in embodiments of this application are merely for the purpose of describing specific embodiments, but are not intended to limit this application. Terms “a”, “the”, and “this” of singular forms used in embodiments of this application are also intended to include plural forms, unless otherwise specified in a context clearly.

In conclusion, the foregoing embodiments are merely intended for describing the technical solutions of this application, but not for limiting this application. Although this application is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of embodiments of this application.

What is claimed is:

1. A method for mode switching, comprising:
sending, by a first communication apparatus, a first signal to a second communication apparatus, wherein the first signal indicates that the first communication apparatus requests to switch a mode of the first communication apparatus, the mode comprises a first mode and a second mode, and there is a correspondence between the mode and a service type of the first communication apparatus; and
switching, by the first communication apparatus, the mode.

2. The method according to claim 1, wherein the first signal is a physical layer signal.

3. The method according to claim 1, wherein:
in response to at least that the service type of the first communication apparatus is an enhanced mobile broadband (eMBB) type, the first mode comprises at least one of an idle state or an inactive state, and the second mode comprises a connected state;
in response to at least that the service type of the first communication apparatus is an internet of things (IoT) type, the first mode comprises the idle state, and the second mode comprises at least one of the inactive state or the connected state; or
in response to at least that the service type of the first communication apparatus is an ultra-reliable low-latency communication (URLLC) type, the first mode comprises the at least one of the idle state or the inactive state, and the second mode comprises the connected state.

4. The method according to claim 1, wherein the first signal is a sounding reference signal (SRS), a scheduling request (SR), or a preamble sequence.

5. The method according to claim 4, wherein the first signal comprises identifier information of the first communication apparatus.

6. The method according to claim 1, wherein the first signal is a dedicated mode switching request signal.

7. The method according to claim 6, wherein there is a correspondence between a frame structure of the first signal and the service type of the first communication apparatus.

8. The method according to claim 1, wherein before the switching, by the first communication apparatus, the mode, the method further comprises:
receiving, by the first communication apparatus, first response information from the second communication apparatus; and
the switching, by the first communication apparatus, the mode comprises:
switching, by the first communication apparatus, the mode based on the first response information.

9. The method according to claim 1, wherein the first signal indicates a request from a group of communication apparatuses to perform mode switching, and the first communication apparatus is comprised in the group of communication apparatuses.

10. The method according to claim 9, further comprising:
receiving, by the first communication apparatus, second response information from the second communication apparatus; and
sending, by the first communication apparatus, a mode switching indication to a third communication apparatus, wherein the third communication apparatus is comprised in the group of communication apparatuses.

11. The method according to claim 1, wherein the method further comprises:
in response to at least that the mode of the first communication apparatus is the second mode, switching, by the first communication apparatus, from the second mode to the first mode based on a timer.

12. The method according to claim 8, wherein the first response information comprises at least one of downlink control information (DCI), an acknowledgment (ACK) character, a negative acknowledgment (NACK) character, or higher layer signaling.

13. The method according to claim 10, wherein the second response information comprises at least one of DCI, an ACK, a NACK, or higher layer signaling.

14. A method for mode switching, comprising:
receiving, by a second communication apparatus, a first signal, wherein the first signal indicates that a first communication apparatus requests to switch a mode of the first communication apparatus, the mode comprises a first mode and a second mode, and there is a correspondence between the mode and a service type of the first communication apparatus; and
determining, by the second communication apparatus, the mode of the first communication apparatus.

15. The method according to claim 14, wherein the first signal is a physical layer signal.

16. The method according to claim 14, wherein:
in response to at least that the service type of the first communication apparatus is an enhanced mobile broadband (eMBB) type, the first mode comprises at least one of an idle state or an inactive state, and the second mode comprises a connected state;
in response to at least that the service type of the first communication apparatus is an internet of things (IoT) type, the first mode comprises the idle state, and the second mode comprises at least one of the inactive state or the connected state; or
in response to at least that the service type of the first communication apparatus is an ultra-reliable low-latency communication (URLLC) type, the first mode comprises the at least one of the idle state or the inactive state, and the second mode comprises the connected state.

17. The method according to claim 14, wherein the first signal is a sounding reference signal (SRS), a scheduling request (SR), or a preamble sequence.

18. The method according to claim 17, wherein the first signal comprises identifier information of the first communication apparatus.

19. The method according to claim 14, wherein the first signal is a dedicated mode switching request signal.

20. A communication apparatus, comprising a transmitter, a switching device, at least one processor, and at least one memory coupled to the at least one processor, the at least one memory storing programming instructions for execution by the at least one processor to cause the communication apparatus to:
send, by the transmitter, a first signal to a second communication apparatus, wherein the first signal indicates that the communication apparatus requests to switch a mode of the communication apparatus, the mode comprises a first mode and a second mode, and there is a correspondence between the mode and a service type of the communication apparatus; and
switch, by the switching device, the mode.
